(19) United States
(12) Patent Application Publication
(10) Pub. No.: US 2006/0061256 A1
(43) Pub. Date: Mar. 23, 2006

(54) Image display device and manufacturing method thereof

(76) Inventors: Noriyuki Oroku, Yokohama (JP); Takashi Naito, Mito (JP); Yuichi Sawai, Hitachi (JP); Tetsu Ohishi, Hiratsuka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/216,063

(22) Filed: Sep. 1, 2005

(30) Foreign Application Priority Data
Sep. 1, 2004 (JP) 2004-253754
Sep. 6, 2004 (JP) 2004-258310

(51) Int. Cl. H01J 1/62

(52) U.S. Cl. 313/496; 313/292

(57) ABSTRACT

In order to obtain an image display device with ease and high reliability in which a space between a display panel and a rear panel opposite thereto is sealed with a frame spacer, in the present invention, a step is formed by partially cutting at least one inner wall of ends connected to each other of a plurality of glass members constituting the frame spacer, or the glass members are connected through a metal fitting which is inserted between ends connected to each other of the glass members.

The present application claims priority from Japanese applications JP2004-253754 filed on Sep. 1, 2004 and JP2004-258310 filed on Sep. 6, 2004, the contents of which are hereby incorporated by reference into this application.

### BACKGROUND OF THE INVENTION

1. Field of the Invention

The present invention relates to an image display device and a manufacturing method thereof, and more particularly, to a panel structure suitable for an emissive flat-panel display and a manufacturing method thereof.

2. Description of the Related Art

Recently, in image display devices, emissive flat panel displays have remarkably been put to practical use in comparison with a liquid crystal display, and a variety of flat panel structures have been proposed.

As described in, for example, Japanese Patent Application Laid-Open No. 7-122189, Japanese Patent Application Laid-Open No. 2002-373587 (and its counterpart U.S. Pat. No. 6,632,113), and U.S. Pat. No. 6,126,505, an emissive flat panel display is generally composed of a display panel having a fluorescent screen, a rear panel having electron sources for irradiating the fluorescent screen with electron beams, and a frame-like member (e.g., a ring-like frame) made of an insulating material such as glass for hermetically sealing the peripheries of the panels in order to provide a flat space between the two panels. If the display screen (display area) of an image display device is compared to a picture, the frame-like member can be compared to a rectangular frame surrounding the periphery of the picture.

FIGS. 19A and 19B show the structure of an emissive display device that is provided with a first substrate having a plurality of electron sources (electron emission elements) formed on a principal surface thereof for each pixel and a second substrate opposing the principal surface of the first substrate and having a principal surface on which a material layer emitting light by receiving electrons from the electron sources is formed. This kind of emissive display device is also referred to as an electron emission display device. One of the typical emissive display devices is a field emission display (FED). FIG. 19A is a perspective view showing the structure of the emissive display device in a state of cutting a part of the second substrate and a part of a frame for sealing a space between the substrates. FIG. 19B is a sectional view showing the display device cut in the X direction of the coordinate system shown in FIG. 19A. In FIGS. 19A and 19B, reference numeral 1 denotes a rear panel (a cathode substrate); 2, a display panel (an anode substrate); 2a, a glass substrate constituting the display panel; 2b, a fluorescent screen formed on the glass substrate 2a; 2c, a metal back provided on the fluorescent screen 2b; 3, a hermetic-sealing frame (a frame spacer) shaped in the form of a rectangle or a ring; and 4, a spacer for supporting the panels that maintains the gap between the rear panel 1 and the display panel 2 at a constant distance. The substrate 1 which is specified as a “rear panel” in this specification is also referred to as a cathode substrate because the plurality of electron sources (cathodes) are disposed on a principal surface thereof. The substrate 2 which is specified as a “display panel” in this specification is also referred to as an anode substrate because electrons emitted from the electron sources are received on a principal surface thereof.

FIG. 20 is a sectional view in the thickness direction of the display device showing an enlargement of an electron source provided at one pixel in the display device and a material layer (fluorescent screen 2b) emitting light by receiving electrons (an electron beam) emitted from the electron source. FIG. 20 shows a sectional view of an FED that applies an electric field to a conical electron source (referred to as a Spindt type) and allows the electron source to emit electrons. However, emissive display devices that will be hereinafter discussed in this specification are not limited to this kind of FED but also include a display device provided with an electron source having a metal-insulator-metal (MIM) junction and a display device provided with an electron source having a carbon nanotube (CNT). A surface-conduction electron-emitter display (SED) provided with an electron source called a surface-conduction electron-emitter is one of the emissive display devices that will be discussed in this specification. The SED can emit electrons from the surface-conduction electron-emitter without applying an electric field to the electron source.

The X-axis and the Y-axis intersecting the X-axis of the coordinate system shown in FIG. 19A forms a plane (X-Y plane) which indicates the display screen of the display device. Therefore, the plurality of electron sources are disposed on the principal surface of the substrate 1 in the X-Y plane in two dimensions. On the other hand, the Z-axis which intersects the X-axis and the Y-axis respectively (in other words, intersects the X-Y plane) corresponds to the thickness direction of the display device (flat panel display). The coordinate system defined above is quoted not only in FIGS. 19A, 19B and 20, but also, as necessary, in drawings according to embodiments of the invention described later. Further, in the coordinate system, the X-axis, Y-axis, and Z-axis do not need to intersect each other at right angles, but it is sufficient that they have a relationship of only intersecting each other.

### SUMMARY OF THE INVENTION

In conventional assembly of this kind of flat panel display, in a state of positioning the rear panel 1 and the display panel 2 through the hermetic-sealing frame 3 generally molded in the form of a rectangular loop or a ring beforehand (a frame generally molded out of a plurality of glass bars), they are heated, bonded and fixed with an adhesive such as frit, and then hermetically sealed through an exhaust process.

As screen sizes increase, the hermetic-sealing frame 4 increases in size so that conventional glass fabrication techniques become incapable of coping with it. That is, in a conventional manner, glass bars are cut from a glass plate of the same substance as a display panel, put into a die, and sintered in one piece with a high-temperature press furnace. A large panel requires a special high-temperature press furnace having a size accommodating the panel and necessary welding pressure, so that there has been a problem in mass-producibility.

On the other hand, in the case of using a frame glass assembled beforehand by bonding pieces of glass using ordinary glass frit, it is necessary to ensure temperature hierarchy in glass frit so that the frame glass does not disassemble or does not cause mutual position deviation at the time of sealing a panel body. However, it is difficult to ensure enough temperature hierarchy in the case of carrying out the assembly process using ordinary frit within the heat resistance of these components and the circuit structure. Therefore, in the case of assembling a panel body using the frame glass 3 formed by bonding glass bars beforehand using ordinary glass frit, there have been problems that the frame glass becomes deformed and deviates from a predetermined position and the sealing of the periphery of the panel easily becomes incomplete during the heat treatment process of heating and mutually fixing the panel body which is a stacked structure of the rear panel (cathode plate) 1, the hermetic-sealing frame (frame glass) 3, and the display panel (anode plate) 2.

On the other hand, in the above-described technique, since the frame glass 3 is molded beforehand from pieces of glass in the form of a rectangle (polygon) or a ring in accordance with the panel size, the unit price of the component becomes high. Further, since an expensive apparatus having a special structure is required during panel bonding, the cost becomes high.

Furthermore, there is also a method of cutting a frame glass from a glass plate in the form of a rectangle (polygon) or a ring in accordance with the panel size. However, in this case, the material use efficiency is poor and special processing is necessary for cutting it in the form of a rectangle, thus increasing the cost and causing a problem in mass-producibility.

Accordingly, it is an object of the present invention to provide an image display device (emissive flat panel display) that resolves the above-described conventional problems and has excellent mass-producibility at low cost and excellent reliability with the panel body assembled with good quality and a manufacturing method thereof.

Hereunder is a description of the representative examples of structures of image display devices (emissive flat panel displays) suitable for achieving the object of the invention and manufacturing methods thereof.
(1) An image display device of a first structure example comprises a display panel (an insulating substrate, a transparent substrate) having a fluorescent screen; a rear panel (an insulating substrate) having an electron source for irradiating the fluorescent screen with an electron beam; and a frame (a frame-like member shaped like a polygon or a ring enclosing a space to be sealed), for hermetically sealing the peripheries of the panels in order to provide a flat space between the two panels, wherein the frame is composed of a bonded unit in which glass members is extended in at least each one direction from each end of the glass members and shaped are assembled in a frame shape, at least one of each pair of ends of the glass members connected to each other has a step portion that is cut so that the glass members do not mutually shift to the inside of the flat space, and the step portion is formed such that a width along at least one direction of the glass member in a plane where the flat space spreads is stretched from the flat space toward the outside of the flat space.

Further, an image display device of the first structure example comprises a first substrate having a principal surface on which a plurality of electron sources are formed; a second substrate being arranged opposite to the principal surface of the first substrate and having a principal surface on which a material layer emitting light by receiving electrons from the electron sources is formed; and a frame-like assembly interposed between the principal surface of the first substrate and the principal surface of the second substrate to seal an area of the principal surface of the first substrate where the plurality of electron sources are formed together with the principal surface of the second substrate. The image display device of the first structure example is also characterized as follows.

The frame-like assembly is shaped by connecting each pair of ends of a plurality of glass members adjacent to each other in a bonding surface of the frame-like assembly to be bonded to one of the principal surface of the first substrate and the principal surface of the second substrate. The plurality of glass members are arranged in a frame shape in the bonding surface.

Each of the plurality of the glass members is extended in at least one direction (hereinafter referred to as an extension direction) from an end of the glass member in the bonding surface of the frame-like assembly, and has an end face transverse to the at least one extension direction being formed at the end, an inner wall being extended along the at least one extension direction while facing an area enclosed by the frame-like assembly, and an outer wall being extended along the at least one extension direction while opposite to the inner wall to form an outer circumference of the frame-like assembly. Each of the end face, the inner wall, and the outer wall is transverse to the bonding surface of the frame-like assembly.

At least one of each pair of the ends of the glass members connected to each other has a first side wall formed between the inner wall and the end face and a second side wall formed between the first side wall and the end face. The first side wall is stretched toward the outer wall along a plane transverse to the inner wall and the at least one extension direction. The second side wall is stretched opposite to the outer wall along another plane transverse to the end face and the first side wall. Each of the first side wall and the second side wall is transverse to the bonding surface of the frame-like assembly to be bonded with another of the each pair of the ends of the glass members connected to each other.
(2) Further, an image display device of a second structure example comprises a display panel having a fluorescent screen; a rear panel having an electron source for irradiating the fluorescent screen with an electron beam; and a frame for hermetically sealing the peripheries of the panels in order to provide a flat space between the two panels, wherein the frame is composed of a bonded unit in which a plurality of glass members being extended in at least each one direction from each end of the glass members and formed, an end of one of the glass members and an end of another glass member are connected to each other through a corner metal fitting at a corner of the frame to be assembled in a frame shape.
(3) Further, a manufacturing method of the image display device of the first structure example comprises the steps of stacking a display panel having a fluorescent screen, a rear panel having an electron source for irradiating the fluorescent screen with an electron beam, and a frame for hermetically sealing the peripheries of the panels in order to provide a flat space between the two panels; and fixing a stacked unit in one piece by heat treatment, wherein, the frame is composed of a bonded unit in which bar-like glass members are assembled in a frame shape, and each of the bar-like glass members has step portions that are cut at both ends so that the glass members do not mutually shift to the inside (so-called flat space enclosed by the frame-like assembly).
(4) Further, a manufacturing method of the image display device of the second structure example comprises the steps of stacking a display panel having a fluorescent screen, a rear panel having an electron source for irradiating the fluorescent screen with an electron beam, and a frame for hermetically sealing the peripheries of the panels in order to provide a flat space between the two panels; and fixing a stacked unit in one piece by heat treatment, wherein, the frame is composed of a bonded unit in which an end of one of the bar-like glass members and an end of another bar-like glass member are connected to each other through a corner metal fitting to be assembled in a frame shape.
(5) Further, in the manufacturing method of the image display device described in item (3) or (4), it is preferable that in the step of fixing a stacked unit in one piece by heat treatment, the inside of the flat space between the two panels be evacuated and depressurized compared to the outside of the flat space in order to ensure the mutual bonding of the two panels and the frame.
(6) An image display device of a third structure example comprises a display panel having a fluorescent screen; a rear panel having an electron source for irradiating the fluorescent screen with an electron beam; and a frame for hermetically sealing the peripheries of the panels in order to provide a flat space between the two panels.

The frame has a “side” in accordance with each of a plurality of bar-like glass members arranged in a frame shape and a “corner” formed by a pair of the bar-like glass members being extended in the respective directions transverse to each other of the bar-like glass members. The plurality of bar-like glass members constituting the frame are connected in the following manner at each corner constituting the frame and assembled into a bonded unit. That is, an end of a bar-like glass member being extended in a first direction to a corner of the frame and an end of another bar-like glass member being extended in a second direction transverse to the first direction to the corner are connected to each other through a corner member having respective ends in the first direction and the second direction.

Each end of the corner member is provided with a surface supporting the bar-like glass member or the other bar-like glass member. This surface touches an end face transverse to an extension direction of the bar-like glass member or the other bar-like glass member.
(7) Further, a manufacturing method of the image display device of the third structure example comprises the steps of stacking a display panel having a fluorescent screen, a rear panel having an electron source for irradiating the fluorescent screen with an electron beam, and a frame for hermetically sealing the peripheries of the panels in order to provide a flat space between the two panels; and fixing a stacked unit in one piece by heat treatment under pressure, wherein, the frame is composed of a bonded unit in which four bar-like glass members are assembled in a frame shape through a corner member, and a projected portion provided at the inside of an end of the corner member restrains the inside of an end of the bar-like glass member from causing a position shift. The term “inside” refers to a space enclosed by the frame (frame-like assembly) as mentioned in the manufacturing method of the image display device of the first structure example and corresponds to the flat space or the sealed area in the image display device. For example, a projected portion provided at the inside of an end of the corner member projects into the space from the surface of the end of the corner member facing the space enclosed by the frame. The “inside” mentioned hereinafter is defined as this kind of space (the inside of the frame).
(8) In the manufacturing method of item (7), it is preferable that in the step of fixing a stacked unit in one piece by heat treatment, the inside of the flat space between the two panels be evacuated and depressurized compared to the outside of the flat space in order to ensure the mutual bonding of the two panels and the frame.

In a series of assembly processes of the display device. (display panel), bar-like glass members necessarily form a glass frame in the form of a rectangle or a ring, instead of assembling beforehand a plurality of bar-like glass members into a frame in accordance with a panel shape as a conventional frame glass. Further, the corner member is arranged at a corner of a rectangular (polygonal) frame and a bar-like glass member constituting one side of the frame and another bar-like glass member constituting another side of the frame which intersect at the corner are connected together through the corner member, thereby adjusting the mutual positions of these bar-like glass members with reliability. Thus, a glass frame in a desired form is provided at a desired position in the principal surface (the above-described X-Y plane) of the substrate of the display panel. Therefore, it is possible to achieve an image display device (emissive flat panel display) having a frame glass with low cost and high reliability.

### BRIEF DESCRIPTION OF THE DRAWINGS

FIG. 1A is an exploded view of a frame glass applied to an image display device according to a first embodiment of the present invention;

FIG. 1B is an exploded view of a frame glass applied to an image display device according to a modification of the first embodiment of the invention;

FIG. 1C is an exploded view of a frame glass applied to an image display device according to another modification of the first embodiment of the invention;

FIG. 1D is an exploded view of a frame glass applied to an image display device according to another modification of the first embodiment of the invention;

FIG. 1E is a perspective view showing a state where L-shaped glass bars shown in FIG. 1D are cut continuously by dicing processing;

FIG. 1F is a plan view for explaining features common to the image display devices according to the first embodiment of the invention and its modifications;

FIG. 1G is a plan view for explaining problems arising in a conventional image display device related to the first embodiment of the invention;

FIG. 1H is a plan view for explaining features of the image display device shown in FIG. 1C according to the invention;

FIG. 2 is an exploded view of a frame glass applied to an image display device according to a second embodiment of the invention;

FIG. 3 is an exploded view of a frame glass applied to an image display device according to a third embodiment of the invention;

FIG. 4 is an exploded view of a frame glass applied to an image display device according to a fourth embodiment of the invention;

FIG. 5 is an exploded view of a frame glass applied to an image display device according to a fifth embodiment of the invention;

FIG. 6 is a flow diagram explaining the manufacturing process of the image display devices according to the first to fourth embodiments of the invention;

FIG. 7 is an explanatory schematic view showing the manufacturing process of the image display devices according to the first to fourth embodiments of the invention;

FIG. 8 is an exploded perspective view of a frame glass applied to an image display device according to a sixth embodiment of the invention;

FIG. 9 is an exploded plan view of a frame glass applied to an image display device according to a sixth embodiment of the invention;

FIG. 10 is a plan view showing a process for temporarily fixing a frame glass applied to an image display device according to a sixth embodiment of the invention;

FIG. 11 is a schematic view of a tray for storing corner members applied to the manufacture of an image display device according to a sixth embodiment of the invention;

FIG. 12 is an exploded perspective view of a frame glass applied to an image display device according to a seventh embodiment of the invention;

FIG. 13 is an exploded plan view of a frame glass applied to an image display device according to a seventh embodiment of the invention;

FIG. 14 is a plan view showing a process for temporarily fixing a frame glass applied to an image display device according to a seventh embodiment of the invention;

FIG. 15 is an exploded perspective view of a frame glass applied to an image display device according to an eighth embodiment of the invention;

FIG. 16 is an exploded plan view of a frame glass applied to an image display device according to an eighth embodiment of the invention;

FIG. 17 is a plan view showing a process for temporarily fixing a frame glass applied to an image display device according to an eighth embodiment of the invention;

FIG. 18 is a perspective view schematically showing the manufacturing process of the image display devices according to the sixth to eighth embodiments of the invention;

FIG. 19A is a perspective view in which the structure of a conventional flat panel body is partially cut;

FIG. 19B is a sectional view in the X direction; and

FIG. 20 is a sectional view showing an enlargement of the vicinity of a pixel of a conventional flat panel.

### DETAILED DESCRIPTION

The structures of typical image display devices of the present invention and manufacturing examples thereof will be further described in the following embodiments.

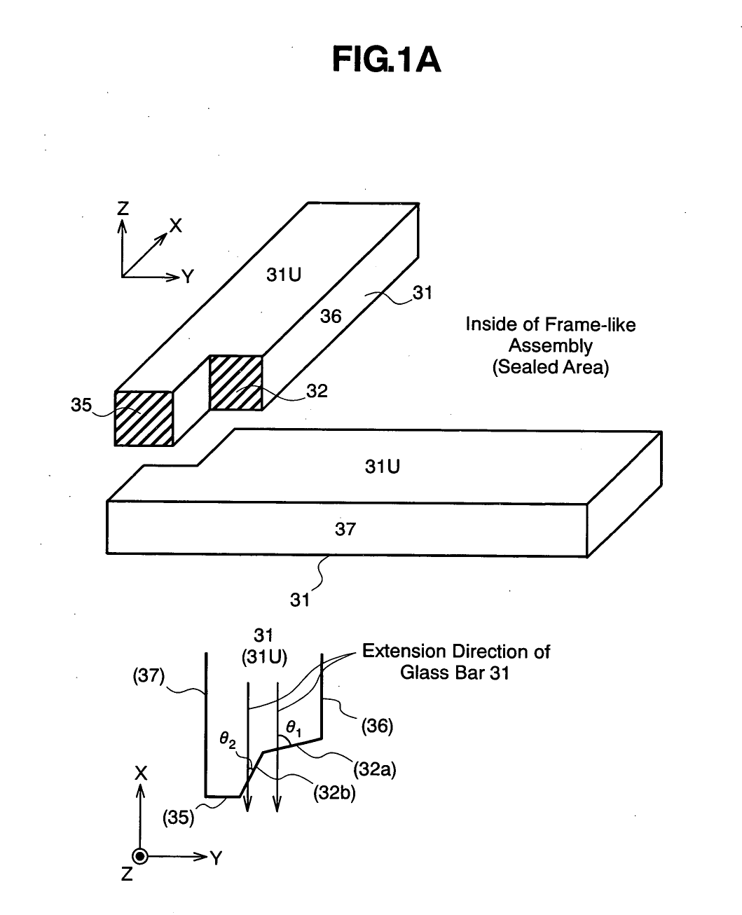

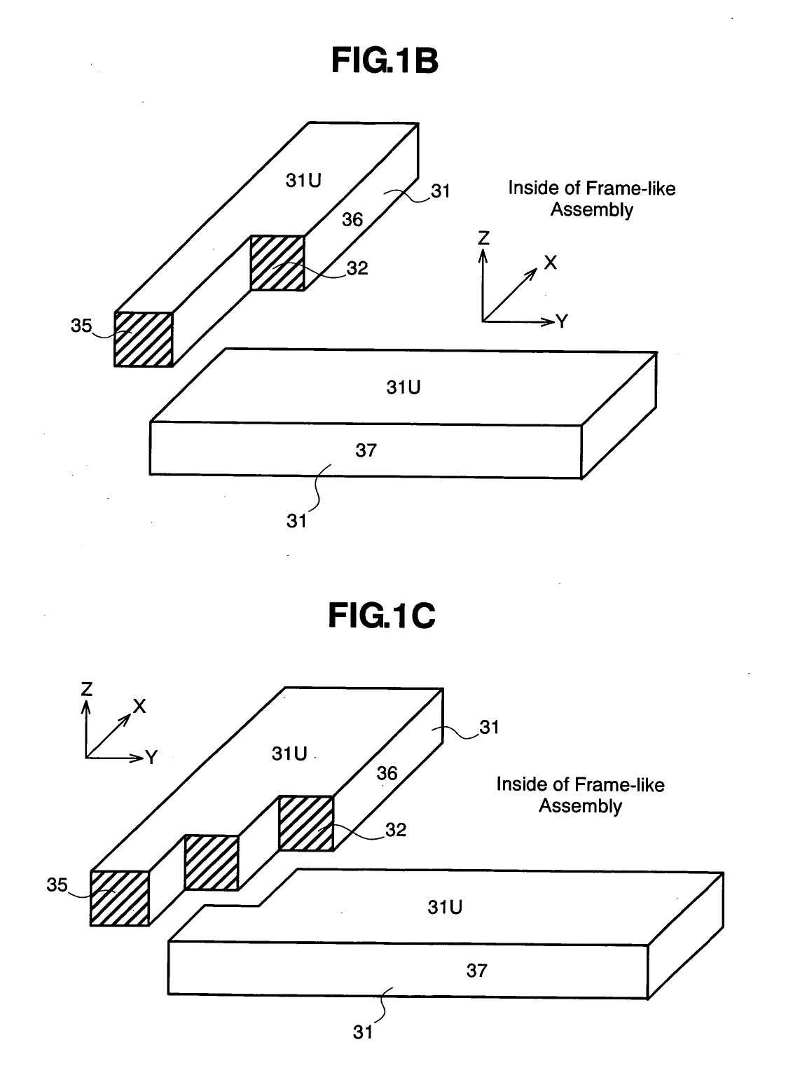

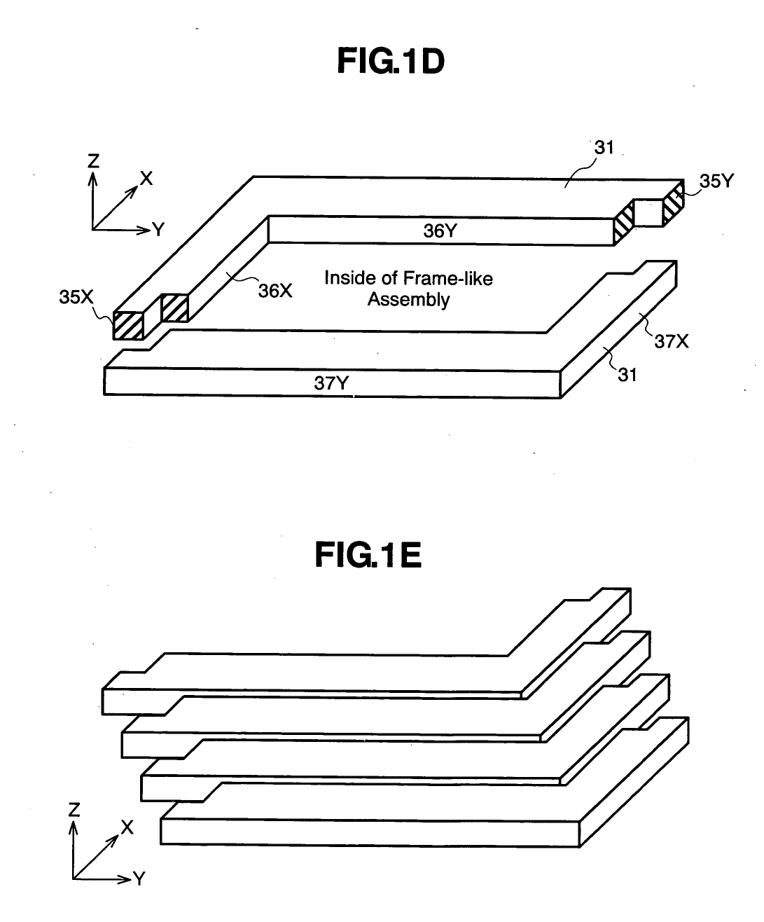

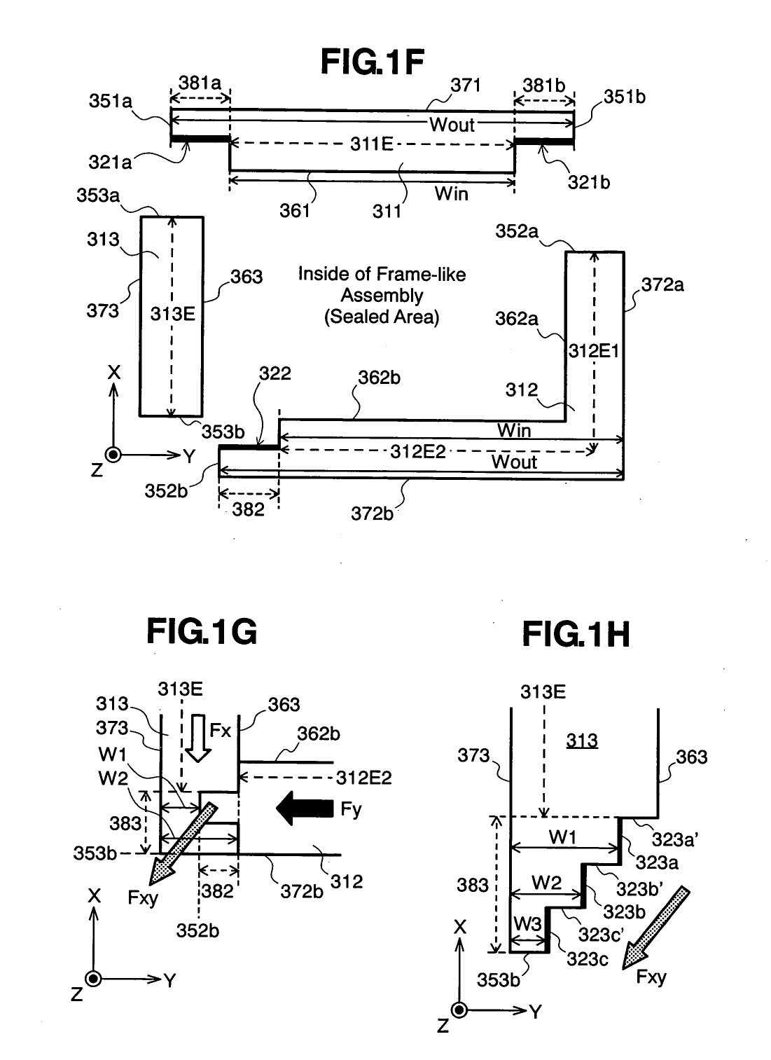

Embodiments of the present invention that are characterized by a frame-like assembly (hereinafter referred to as a frame glass) for sealing a space between a pair of substrates of an image display device will be described more specifically with reference to FIGS. 1 to 7.

[Embodiment 1]

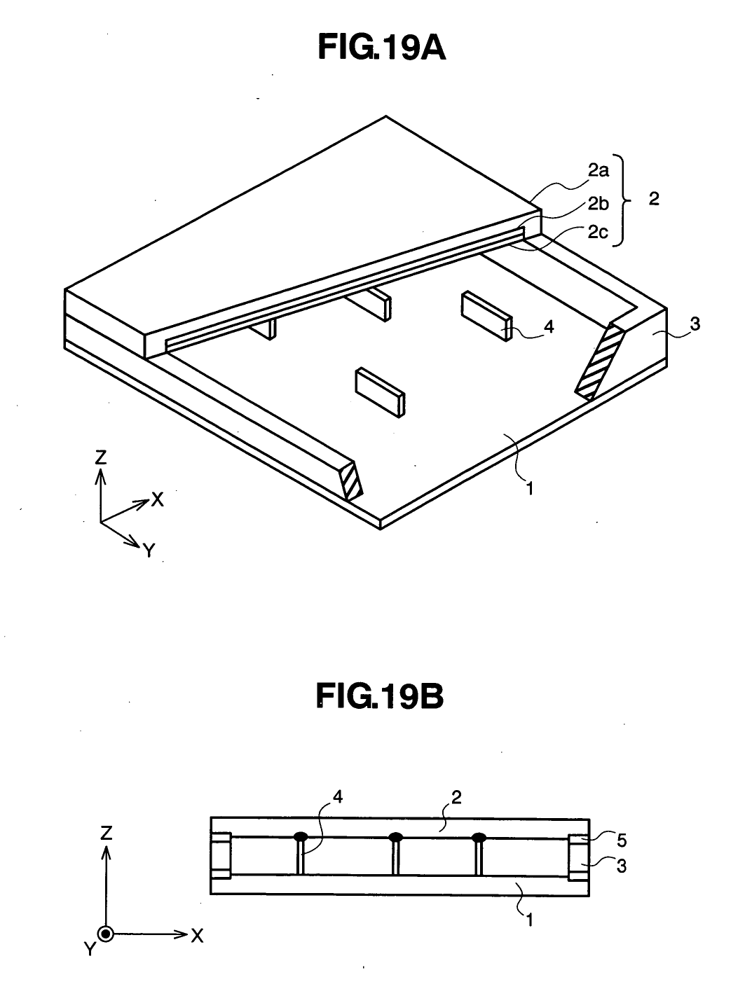

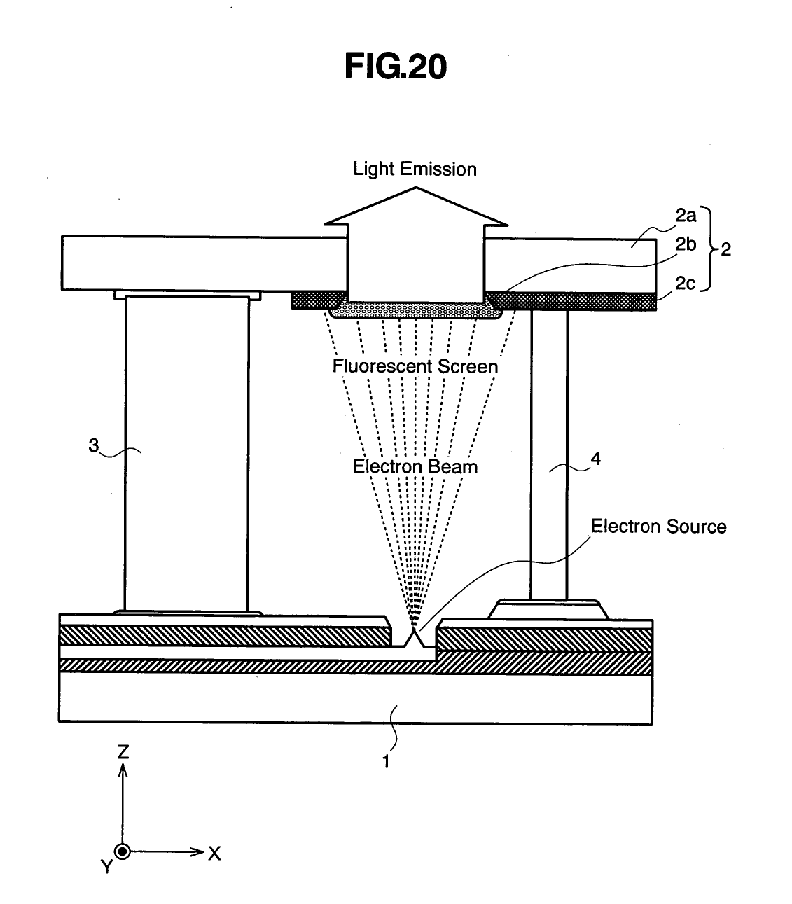

FIG. 1 shows a first embodiment of the present invention. The whole structure of the image display device (emissive flat panel display) of the invention is almost the same as that of the conventional flat panel display shown in FIGS. 19A and 19B except for the structure of the frame glass 3. Thus, in this embodiment, the structure of the frame glass 3 which is a feature of the invention will be mainly described.

FIG. 1A is a perspective view schematically showing one end of a glass bar constituting the frame glass 3. FIG. 1A shows a pair of glass bars (sealing parts) 31 adjacent to each other forming, for example, the rectangular frame glass (frame-like assembly) 3. The one of the pair is a rectangular parallelepiped extending in the X direction, and the other is a rectangular parallelepiped extending in the Y direction. Each of the glass bars 31 has a surface 31U (also referred to as a top surface, for convenience) bonded to one of “the periphery of the principal surface of the cathode plate 1 surrounding an area where a plurality of electron sources are formed” and “the periphery of the principal surface of the anode plate 2 opposing the principal surface of the cathode plate 1”, and a surface at the opposite side (also referred to as an under surface for convenience, hidden in FIG. 1A) bonded to the other one of the periphery of the principal surface of the cathode plate 1 and the periphery of the principal surface of the anode plate 2. These surfaces are along the X-Y plane (the display screen of the image display device) and intersect the Z direction (the thickness direction of the image display device) in FIG. 1A. Each of the glass bars 31 also has side surfaces (side walls) 35, 36 and 37 that spread in planes intersecting the top surface 31U and the under surface (at least along the Z direction). In the coordinate systems shown in FIG. 1A and other drawings, the X-axis, Y-axis, and Z-axis do not need to intersect each other at right angles, but it is sufficient that each pair of them only intersect each other.

These glass bars 31 are bonded at each one end and form a corner of the frame glass (frame-like assembly) 3. In FIG. 1A, an area (in the X-Y plane) surrounded by the frame-like assembly formed with the glass bars 31 etc. is referred to as “the inside of the frame-like assembly” with respect to the pair of glass bars 31. When the cathode plate 1 and the anode plate 2 are bonded to the top surfaces 31 and the under surfaces of the glass bars 31 constituting the frame-like assembly, “the inside of the frame-like assembly” becomes the sealed area. Therefore, a side wall facing the inside of the frame-like assembly (sealed area) out of the side walls of the glass bar 31 is also referred to as an inner wall 36. A side wall (not facing the inside of the frame-like assembly) opposite to the inner wall 36 is also referred to as an outer wall 37. In the glass bar 31 extending in the X direction, the top surface 31U and the under surface along the X-Y plane, and the inner wall 36 and the outer wall 37 along the X-Z plane intersecting the X-Y plane extend in the X direction and terminate at the side wall (end surface) 35 intersecting the X direction (extension direction). The top surface 31U and the under surface of the glass bar 31 are bonding surfaces to the frame glass (frame-like assembly) 3.

At each end of the glass bars 31 bonded to each other, as shown in FIG. 1A, the inner wall 36 is recessed toward the outer wall 37 along the direction intersecting the extension direction and processed such that a step is produced in the X-Y plane. In the glass bar 31 extending in the X direction, the step 32 is composed of a first side wall 32a that is adjacent to the inner wall 36 and spreads in a plane intersecting the inner wall 36 and a second side wall 32b that is adjacent to the first side wall 32a and the end surface 35 and spreads in a plane intersecting the first side wall 32a and the end surface 35. As long as this relationship is satisfied, in the glass bar 31 extending in the X direction, the first side wall 32a may intersect the Y-Z plane, and the second side wall 32b may intersect the X-Z plane. A step in the glass bar 31 extending in the Y direction is also formed with a first side wall and a second side wall having this relationship. Let us define the first side wall 32a and the second side wall 32b in general. The first side wall 32a intersects the extension direction of the glass bar 31 at a first angle of θ₁. The second side wall 32b intersects the extension direction of the glass bar 31 at a second angle of θ₂ (<θ₁) which is smaller than the first angle of θ₁, or does not intersect it (θ₂=0). The first side wall 32a is along a plane intersecting the top surface 31U and the under surface of the glass bar 31, and the second side wall 32b is along another plane also intersecting the top surface 31U and the under surface of the glass bar 31. In the description below, a pair of the first side wall 32a and the second side wall 32b adjacent to the first side wall 32a is referred to as a “step”. The number of steps at the end of the glass bar 31 where N (a natural number) sets of the pair are formed between the inner wall 36 and the end surface 35 is specified as (N+1) steps.

The end of the glass bar 31 is processed into the bar with the step as shown in FIG. 1A. Low melting point glass frit is applied to the first side wall 32a and the second side wall 32b which are bonding surfaces to the end of another glass bar 31. After drying the frit, pre-baking is performed. In the structure of the step 32 of each glass bar 31, a cut is formed in the inner wall 36 of each end of the adjacent glass bars 31 bonded to each other so that four glass bars 31 can be assembled into the frame-like assembly. The depth of the cut (the length along the extension direction of the glass bar 31) is set to about one-half of the width of each glass bar 31 so as to make a minimum gap at the joint of the corner in the case of assembling the glass bars 31 into the frame-like assembly. In this embodiment, the number of steps is two and the depth of the cut is about one-half of the width of the glass bar. However, in a similar structure, the number of steps may be three and the depth of the cut may be about one-third of the width of the glass bar. Further, it is possible to increase the number of steps to three or more.

In this embodiment with reference to FIG. 1A, the numbers of steps at the bonding ends of the glass bars 31 to be assembled are the same. However, as shown in FIGS. 1B and 1C, the respective numbers of steps formed at the ends of the glass bars 31 to be bonded may be mutually different. In the modification shown in FIG. 1B, two steps are formed at the end of one of the glass bars 31, and no step is formed at the end of the other one. With this structure, the tail end of the inner wall and the end surface of the other one are bonded to a first side wall and a second side wall formed at the end of the one of the glass bars. In the modification shown in FIG. 1C, three steps are formed at the end of one of the glass bars 31, and two steps are formed at the end of the other one. With this structure, a pair of a first side wall and a second side wall formed at the other one and the tail end of the inner wall and the end surface are bonded to two pairs of a first side wall and a second side wall formed at the end of the one of the glass bars. In this manner, it is also possible to assemble the glass bars 31 having different steps at the bonding ends.

With the bar-like glass member 31 described above in this embodiment, it becomes possible to assemble a frame glass (frame-like assembly) 3 without adopting a so-called “mortise-tenon joint”, thereby negating the need for complicated mortise-tenon processing in which a tenon is formed at the end of one of the glass members 31 to be joined and a mortise that fits the tenon is formed at the end of the other one. That is, according to this embodiment, it is sufficient to only form a simple step in at least one of the glass members 31, thus facilitating part processing. In the case of using the mortise-tenon processing, although it is relatively easy to cut and process a projection (tenon), it is relatively difficult to form a recess in a glass bar because stress that tears the glass bar easily occurs at the time of processing a recess (mortise).

In the case of the step processing shown in this embodiment, it is possible to cut and process a glass bar using a dicing blade which hardly causes a crack, and has good processing efficiency. Further, in the case of the shape of the glass member 31, even if a crack develops during processing, the crack easily stops at the end of a previously processed surface. Therefore, the processing in the form of the glass member 31 is much easier than the conventional mortise-tenon processing.

Glass bars with steps thus processed are disposed, in the form of a frame, on the periphery of the display panel 2 where a fluorescent screen is formed, this frame-like glass 3 are hold with the rear panel 1 where electron sources are formed, and they are heated and bonded into one unit. By thus sealing the display panel 2 and the rear panel 1 through the frame-like glass 3, a flat panel display is completed.

Further, since the step portions of the glass bars 31 become stuck to each other during heating and bonding, evacuating the display area to a lower pressure does not cause position deviation of the frame glass, so that the frame glass can be fixed at a desired position for the panel. That is, in the present invention, there is a meaning in that the bar-like glass members of the frame glass are temporarily fixed so as not to shift inward and can be fixed with glass frit melting at the same temperature range and at the same timing as in sealing the body.

In an emissive image display device such as an FED, it is possible to make a structure in which a high-voltage lead is not provided at a corner of the panel; therefore, there is little constraint in dimensions and in electric circuits at the corner. If the glass bars do not shift inward, baking in the panel assembling becomes possible by only holding the glass bars lightly from the outside, thereby negating the need for an expensive, high-accuracy baking mold. Further, the glass frame can be assembled and fixed, concurrently with the panel assembling. These features show excellent mass-producibility.

Further, as a modification of this embodiment, the glass bars to be assembled may be L-shaped members instead of linear members. FIG. 1D shows this modification. Each of the L-shaped glass members 31 extends in the X direction and in the Y direction from a corner of the frame glass formed with the pair and terminates at end surfaces 35X and 35Y respectively. Further, each of the L-shaped glass members 31 has an inner wall 36X extending in the X direction, an inner wall 36Y extending in the Y direction, an outer wall 37X extending in the X direction, and an outer wall 37Y extending in the Y direction. This modification also satisfies a fundamental function of this embodiment for preventing mutual deviation of the glass members 31 by forming the above-described steps in the end of at least one of the X-direction stretch portion and the Y-direction stretch portion of the glass member 31. The original advantage of the first embodiment of processing only the end of a simple bar-like member at low cost is lost. However, L-shaped glass bars are cut continuously from a glass plate member by dicing processing as shown in FIG. 1E, thus making it possible to obtain bars for the frame from the glass plate member with material efficiency. It is possible to combine this modification and the previously described modification of different steps in the step portions.

The features and advantages of the image display devices according to this embodiment and its modifications described above will be summarized with reference to FIGS. 1F to 1H. FIG. 1F is a plan view (X-Y plane) showing three glass members 311, 312, and 313 constituting the above-described frame glass (frame-like assembly) 3. In the glass member 311, a pair of a first side wall and a second side wall (described above) are formed at each end of a stretch portion 311E extending in the Y direction. Therefore, an outer wall 371 extending opposite to an inner wall 361 further extends in the Y direction from both ends of the inner wall 361. The outer wall 371, second side walls 321a and 321b opposite to the outer wall 371, and end surfaces 351a and 351b terminating the extension of the glass member 311 in the Y direction form projections 381a and 381b. Each of the projections 381a and 381b and the stretch portion 311E form the above-described step in the X-Y plane.

As in the case of the glass member 31 shown in FIG. 1D, the glass member 312 changes in extension direction between an end surface 352a and an end surface 352b. The glass member 312 is shaped like a letter L and composed of a first stretch portion 312E1 extending in the X direction and a second stretch portion 312E2 extending in the Y direction. There is no step composed of a first side wall and a second side wall at the end of the first stretch portion 312E1, and an inner wall 362a extending in the X direction and an outer wall 372a extending opposite to the inner wall 362a terminate at an end surface 352a. On the other hand, an outer wall 372b extending opposite to an inner wall 362b further extends in the Y direction from the end of the inner wall 362b. The outer wall 372b, a second side wall 322 opposite to the outer wall 372b, and an end surface terminating the extension of the glass member 312 in the Y direction form a projection 382.

There is no step composed of a first side wall and a second side wall at each end of a stretch portion 313E of the glass member 313 extending in the X direction. Therefore, each one end of an inner wall 363 extending in the X direction and an outer wall 373 extending opposite to the inner wall 363 terminates at an end surface 353a and each other end terminates an end surface 353b.

As seen by comparing the shapes of the glass members 311 to 313, an outer wall extends longer than an inner wall and is opposite to a second side wall, at the end of a glass member where a step described in this embodiment is formed. In the case of the glass member 311 formed like a bar, the outer wall 371 extends in the longitudinal direction and reaches the end surfaces 351a and 351b that intersect the longitudinal direction and terminate the extension of the glass member 311 in the longitudinal direction. However, in light of the glass member 312 composed of a plurality of stretch portions extending in different directions, the outer wall 372b extending from the end surface 352b which is one end of the glass member, in the direction intersecting the end surface and the inner wall 362b extending opposite to the outer wall 372b form the stretch portion 312E2. In either case, the outer wall reaches an end surface which is one end of the glass member, and at least a pair of a first side wall and a second side wall adjacent to the first side wall is formed between the inner wall opposite to the outer wall and the end surface. Further, a distance between the second side wall and the outer wall is shorter than a distance between the outer wall and the inner wall opposite to the outer wall. Further, respective widths Win along the respective extension directions (Y direction) of the stretch portion 311E of the glass member 311 and the second stretch portion 312E2 of the glass member 312 stretch to respective widths Wout at the steps formed in the ends. In either of the glass members 311 and 312, the width Wout along the extension direction at the opposite side is larger than the width Win along the extension direction at the side facing an area (flat space) surrounded by the frame-like assembly. The minimum values of the widths Win are determined by the inner walls 361 and 362b of the stretch portions 311E and 312E2 of the glass members. The maximum values of the widths Wout are determined by the outer walls 371 and 372b of the stretch portions 311E and 312E2. That is, a width along at least one direction of a glass member in the plane where the flat space spreads stretches toward the outside (outer wall) from the flat space (inner wall side).

The first side wall and the second side wall which have already been defined with reference to FIG. 1A also have the following features. The second side wall intersects a plane (assumed plane) parallel to the end surface that the outer wall of the glass member opposite to the second side wall reaches. Further, the second side wall also intersects a plane (assumed plane) parallel to the first side wall adjacent to the second side wall. The step composed of the first side wall and the second side wall does not need to be provided at each glass member (sealing member) constituting the frame-like assembly, and it is sufficient to provide the step in at least one of each pair of glass members bonded together (forming a corner of the frame-like assembly) of the glass members.

As described above, in the step 32 at the end of the glass member constituting the frame-like assembly 3 of the image display device according to this embodiment, the inner wall is recessed in the direction intersecting the extension direction and thereby replaced with the second side wall; however, the outer wall is not recessed. Advantages of such a shape will be described with reference to a comparison example of FIG. 1G in which “a tenon (a projection similar to the tenon)” is formed at one of the pair of ends bonded together of the glass members and “a mortise (a recess into which the projection is inserted)” is formed at the other end following the description of U.S. Pat. No. 6,126,505.

FIG. 1G shows an enlargement of the joint of the glass member 312 (the second stretch portion 312E2) and the glass member 313 shown in FIG. 1F. A projection 382 such as a tenon is formed at the end of the glass member 312, and a recess into which the projection 382 is inserted is formed at the end of the inner wall 363 of the glass member 313. In other wards, both the inner wall 362b and the outer wall 372b of the glass member 312 are recessed at the end of the glass member 312, and a projection 383 extending to the end surface 353b is formed at the end of the stretch portion 313E of the glass member 313. Further, the width of the projection 383 of the glass member 313 (the dimension in the direction intersecting the extension direction) is smaller (W1) at the stretch portion 313E side and larger at the end surface 353b side (W2>W1). That is, the width of the projection 383 stretches stepwise toward the end surface 353b of the glass member 313. The second stretch portion 312E2 of the glass member 312 extends long in the Y direction with respect to the projection 382, and the stretch portion 313E of the glass member 313 extends long in the X direction with respect to the projection 383. For example, the length by which each stretch portion extends in the extension direction is more than five times as long as the length by which the projection sticks out from the stretch portion in the extension direction.

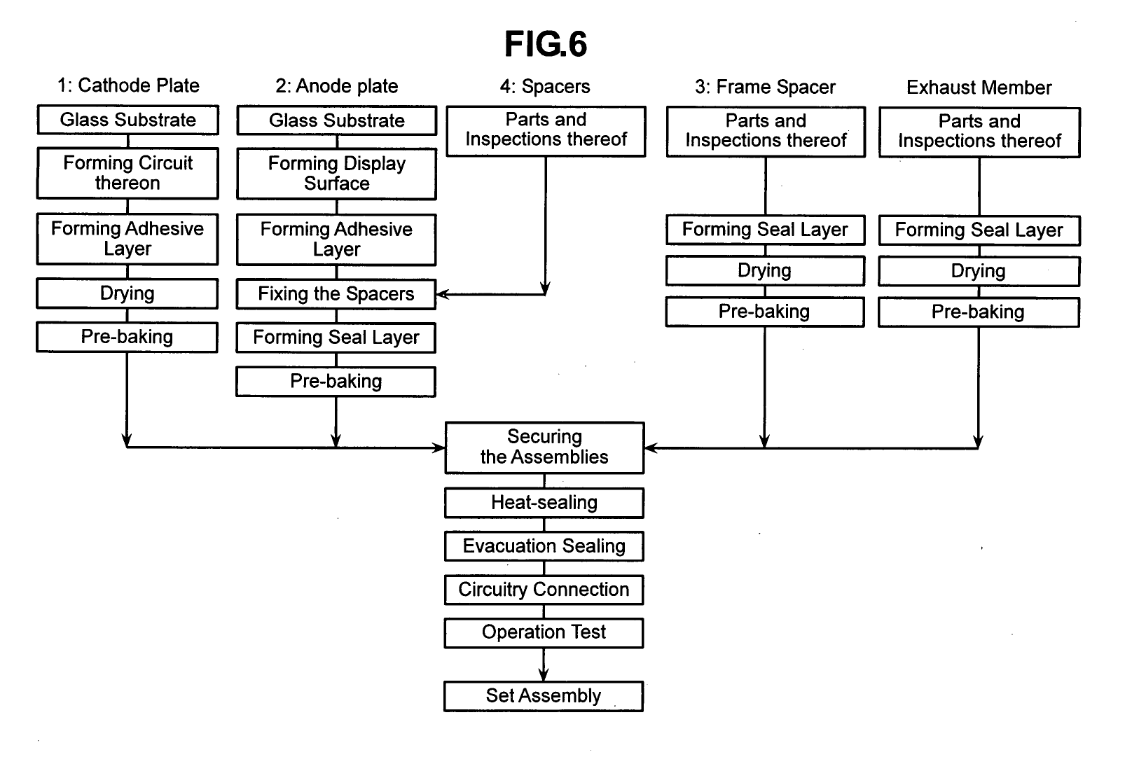

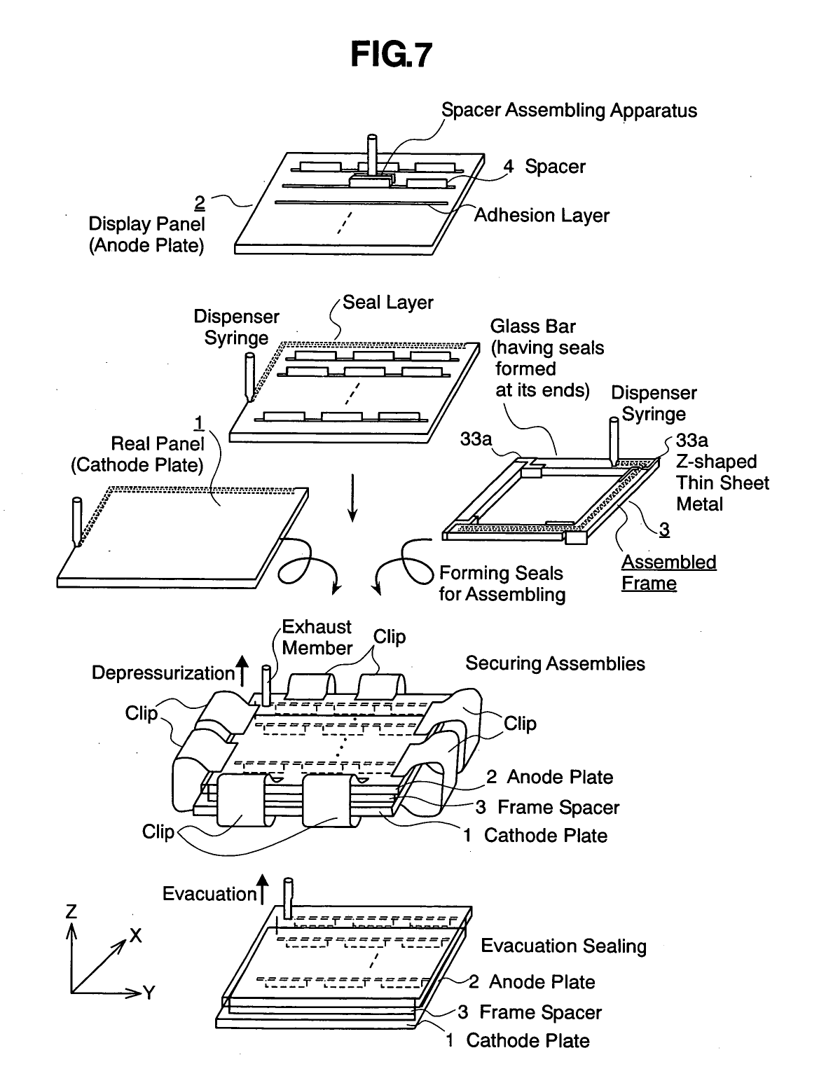

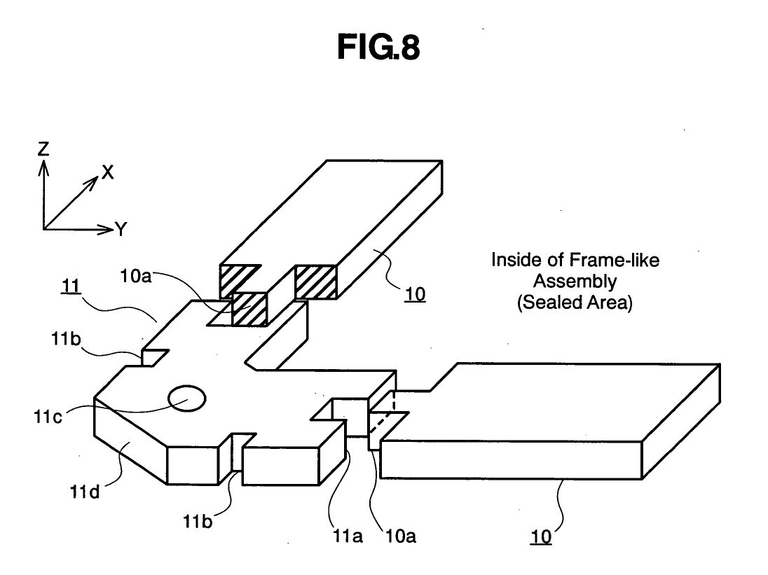

On the other hand, the frame-like assembly 3 composed of such glass members is put between the principal surface of an insulating substrate (cathode plate 1) where a plurality of electron sources are formed and the principal surface of an insulating substrate (anode plate 2) having a material that emits light by electrons incident from the electron sources to be incorporated into a stacked structure in which the cathode plate 1, the frame-like assembly 3, and the anode plate 2 are stacked in this order. In the process of “securing assemblies” of the image display device which will be described later with reference to FIGS. 6 and 7, by heating the stacked structure, the principal surface of the cathode plate 1 (an area where the electron sources are formed) are sealed with the principal surface of the anode plate 2 and the frame-like assembly 3. Therefore, in the process of “securing assemblies”, the glass members constituting the frame-like assembly 3 expand by heating and contract upon completion of the process. As described above, the extension length of the stretch portions 312E2 and 313E of the glass members are much longer than those of the projections 382 and 383 formed at the stretch portions; therefore, the load of thermal expansion along the extension direction of the stretch portions 312E2 and 313E applied to the projections 382 and 383 is also large. A force Fy applied to the projection 382 of the glass member 312 by expansion of the stretch portion 312E2 in the Y direction and a force Fx applied to the projection 383 of the glass member 313 by expansion of the stretch portion 313E in the X direction apply a force Fxy to the joint of the glass members 312 and 313. The force Fxy is applied to the projection 382 in the −X direction, and the projection 383 (a portion having a stretched width of W2) of the glass member 313 adjacent to the outer wall of the projection 382 blocks the absorption of the force Fxy by deformation of the projection 382. As a result, there are cases where the projection 383 is broken by the force Fxy. Further, there are cases where the stretched-width portion in the projection 383 of the glass member 313 is broken by deformation of the projection 382 or the force Fxy applied to the portion in the −Y direction.

The above-described problems are resolved by constructing the frame-like assembly 3 from the glass members with the ends (joints) having the structure characterized in this embodiment. As seen by comparing the shapes of the joints of the glass members 312 and 313 shown in FIG. 1F and those shown in FIG. 1G, the projection 382 of the glass member 312 shown in FIG. 1F (this embodiment) does not block the absorption of the force Fxy applied to the projection 382 by deformation in the −X direction, and the glass member 313 does not block the absorption of the force Fxy by deformation in the −Y direction. Such advantages of this embodiment are obtained because the glass members 312 and 313 are shaped in such a manner that each of the steps at the ends of the glass members 311 and 312 shown in FIG. 1F is along the direction of the force (corresponding to the Fxy) applied to the joint of the glass members by the steps. FIG. 1H is a plan view in which the shape of the steps formed at the end of the glass member 313 following the modification of FIG. 1C and the force Fxy applied to the joint (a corner of the frame-like assembly 3) of the glass members by the steps are enlarged and compared. The base of the advantages of this, embodiment is clearly shown in FIG. 1H.

In the X-Y plane of FIG. 1H, first side walls (323a′, 323b′, 323c′) and second side walls (323a, 323b, 323c) constituting the steps are alternately formed between the inner wall 363 and the end surface 353b of the glass member 313. A first side wall 323a′ (one of the first side walls) is adjacent to the inner wall 363, and a second side wall 323c (one of the second side walls) is adjacent to the end surface 353b. The distance (W1, W2 or W3) between the outer wall 373 of the glass member 313 and the second side walls (323a, 323b, 323c) opposite to the outer wall 373 decreases stepwise toward the end surface 353b (W1>W2>W3). As shown in FIG. 1H, by decreasing the width of the projection 383 extending from the stretch portion 313E of the glass member 313 stepwise toward the end surface 353b, it becomes easy to hold an adhesive material such as glass frit between the surfaces (the first side walls and the second side walls) constituting the steps of the glass member 313 and the surfaces of another glass member bonded thereto. This advantage can be obtained not only from the structures exemplified in FIGS. 1C and 1H but also from the other structures disclosed as this embodiment and its modifications.

Not only the structures exemplified in FIGS. 1C and 1H but also the shapes of the steps formed at the ends of the glass members (sealing parts) disclosed as this embodiment and its modifications prevent the position deviation (shift in the X-Y plane) and the deformation of the joints even if the glass members contract after the completion of heating the frame-like assembly 3.

[Embodiment 2]

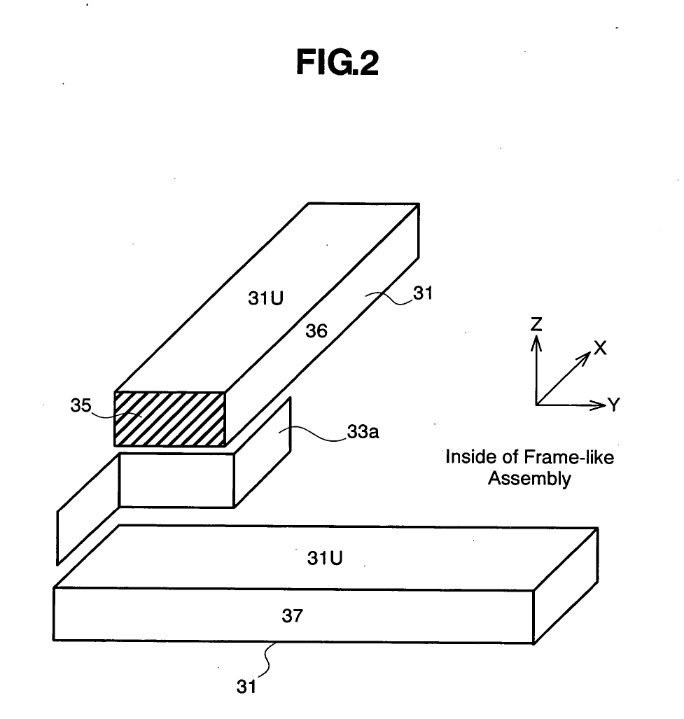

FIG. 2 shows a second embodiment. In this embodiment, glass bars obtained only by cutting a glass plate (e.g., a mother board) are merely connected through metal fittings described later, thereby making it possible to assemble an image display device with accuracy equal to or higher than that of the embodiment 1 in which the glass bars having steps at the ends are directly bonded.

In this embodiment, frame members composed of four glass bars constituting a rectangular glass frame (frame-like assembly) and four corner metal fittings 33a for bonding these frame members are disposed in the form of a frame on the principal surface of the display panel (anode plate) 2. A metal fitting 33a is inserted between the respective ends connected to each other for a pair of glass members 31 adjacent to each other in the principal surface of the display panel 2, and each of the ends is bonded to the metal fitting 33a with glass frit at a high temperature. In FIG. 2, “an end surface 35 (intersecting the X direction)” of the glass member 31 extending in the X direction and “an end of an inner wall (a hidden side from an outer wall 37 in FIG. 2)” facing a flat space (an area surrounded by the glass frames) of the glass member 31 extending in the Y-direction are connected together through the metal fitting 33a. In this embodiment, by fixing the glass bars 31 simply in the form of a rectangular using the corner metal fittings 33a, it is possible to fix the glass bars with stability in a heating furnace. In this manner, an end surface of one of the bar-like glass members and a side surface of the other bar-like glass member are bonded to each other through the corner metal fittings, thus making it possible to construct a glass frame with a bonded unit assembled in the form of a rectangular.

The corner metal fitting 33a is formed with a piece of metal bent like a letter Z. It is desirable that the piece of metal be made of an alloy meeting the thermal expansion coefficient of the glass frame. It is possible to use an alloy containing, for example, 48% nickel (Ni) and 58% iron (Fe).

In this embodiment, the corner metal fittings 33a are added as connecting members in comparison with the first embodiment. However, it becomes unnecessary to form complicated steps in the glass bars 31. On the other hand, since the corner metal fitting 33a is a member formed by bending a simple rectangular member into a right angle, it is possible to produce the corner metal fitting 33a by continuous-press shape processing at low cost. Therefore, there is an advantage that total member cost can be greatly reduced.

[Embodiment 3]

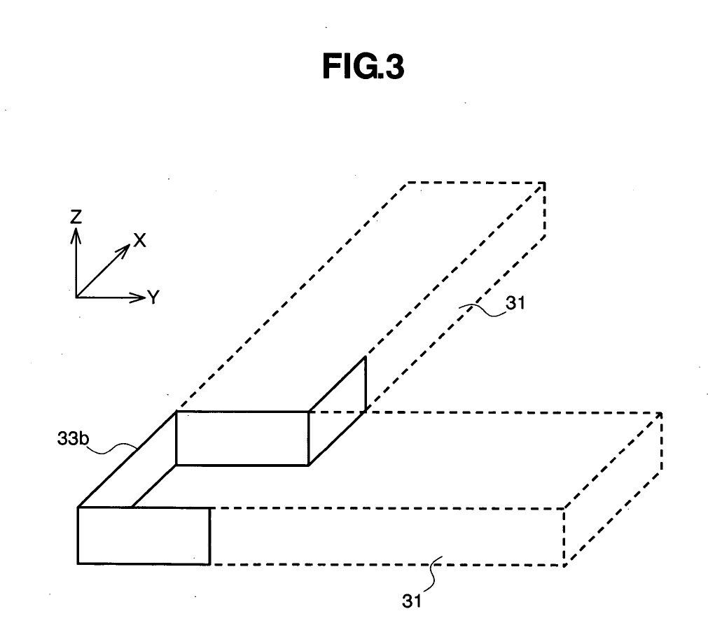

FIG. 3 shows a third embodiment showing a modification 33b in which one end of the corner metal fitting 33a in the second embodiment is further bent into a 90° angle. With the corner metal fitting 33b, the glass bars 31 can be temporarily fixed with more stability.

In this embodiment, the corner metal fitting 33b is further bent into a right angle in comparison with the second embodiment and has parallel portions by two right angle bends with press bend processing, thus slightly complicating a press processing die. However, since the folded portion at the end of the corner metal fitting 33b holds the end of one of the glass bars 31, the prevention of deviation by mutual frictional resistance can be expected, and there is a merit of being able to reduce a possibility that the corner metal fittings 33b rises up from the glass bars 31 in disposing the materials or in the heating process in a furnace.

[Embodiment 4]

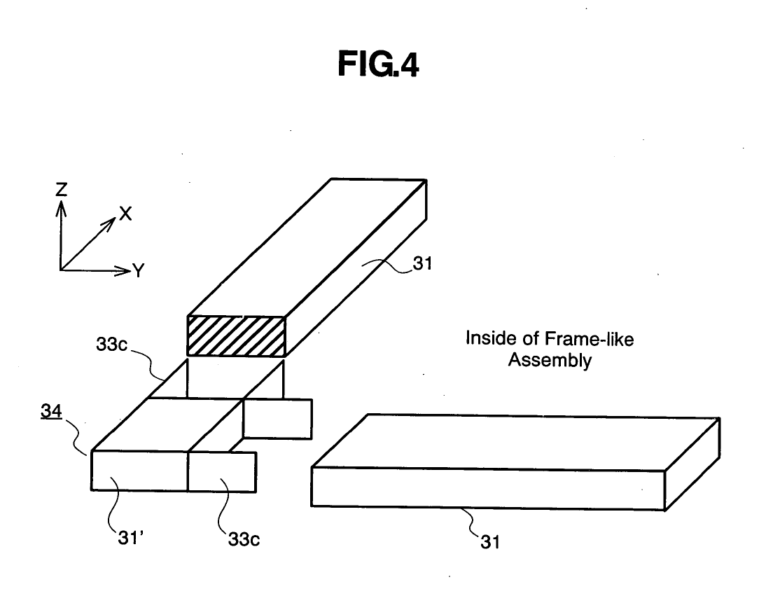

FIG. 4 shows a fourth embodiment. As a corner member 34 for a frame glass, there is prepared a member in which respective U-shaped metal fittings 33c are connected to adjacent side surfaces of a piece of glass 31′. The piece of glass 31′ and the U-shaped metal fittings 33c are bonded together beforehand with high melting point glass frit. Since the piece of glass 31′ and the U-shaped metal fittings 33c are small parts and also the diagonal length at the joint is short, the thermal expansion coefficient of the high melting point glass frit can be adjusted with a margin compared to the bonding of the whole frame glass. Further, since the volume of the connecting members is small, the bonding members can be bonded at low cost using a small high-temperature furnace. The ends of the glass bars 31 are respectively inserted into the U-shaped metal fittings 33c of the corner member 34, thus assembling the frame glass. With this frame glass, two panels are combined in the same manner as in the first embodiment, and the flat panel display is completed.

In the case of using the corner member 34, the positioning of the frame glass during panel assembly is easier than with any of the above-described embodiments. In addition, without position deviation during heat-fixing, a high-reliability flat panel display can be obtained.

[Embodiment 5]

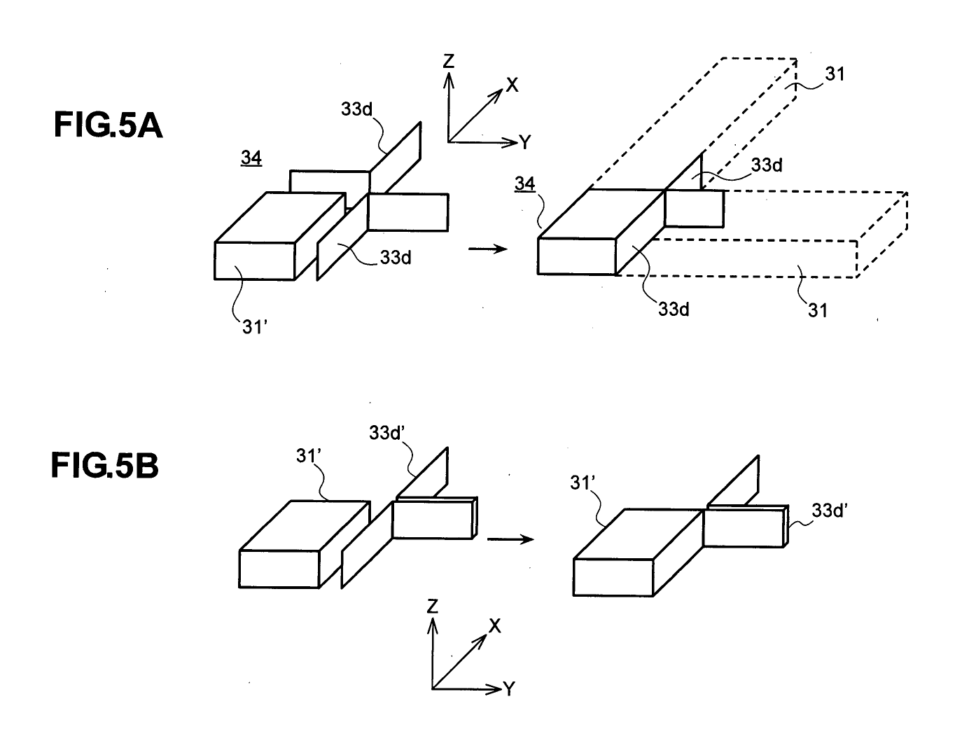

FIG. 5A shows a fifth embodiment. In this embodiment, the metal fitting 33c of the corner member 34 in FIG. 4 is replaced with an L-shaped metal fitting 33d. In this embodiment, as in the case of the fourth embodiment, the positioning of the frame glass during panel assembly is easy, and without position deviation during heat-fixing, a high-reliability flat panel display can be obtained. As shown in FIG. 5B, it is possible to use a T-shaped metal fitting 33d′ with fold-back processing, as a modification of the fifth embodiment. In this case, since the metal fittings 33d can be formed in one piece with one surface bonded to the piece of glass 31′, it becomes easier to fix the members in a small high-temperature furnace during the pre-assembling of the piece of glass 31′ and the metal fitting 33d′, and there is a merit of being able to reduce the manufacturing cost.

As described, the embodiments 2 to 5 have exemplified the fixing method using the metal fittings formed by pressing low-cost thin sheet metal, as frame glass structures.

A manufacturing process of the display device using the frame structures of the embodiments will be described below. FIG. 6 shows a simplified flow of the manufacturing process of the display device. FIG. 7 shows a simplified perspective view of the assembly process. On the anode plate 2 which is a front display panel, spacers 4 are fixed prior to securing the assemblies. The frame spacer 3 is put between the anode plate (display panel) 2 and the cathode plate (rear panel) 1, an exhaust member is installed, and the whole is fixed using jigs or clips and heated. At this time, the volume decreases due to frit melting and the thickness of a frit bonding layer decreases due to the effusion by extrusion from the joints; therefore, it is necessary for the assembly process springs and/or compression by air pressure difference due to internal depressurization for the mutual fixing of these parts.

Although it is possible to perform the sealing using only spring clips on the periphery, the frame members assembled beforehand or the glass bars and the connecting metal fittings installed on the spot are prone to position deviation. The application of compression to the whole by internal depressurization can prevent partial rise of the members. In order to prevent the deviation of the frame spacer 3 due to being pushed inside by external pressure at this time, the Z-shaped corner metal fittings 33a in the second embodiment are provided in FIG. 7. Even though the frit of the joints of the frame spacer 3 melts again by heating at the time of seal assembling, the frame spacer 3 is not crushed because the corner metal fittings 33a support the glass bars 31 against the external pressure. Since the corner metal fittings 33a and the glass bars 31 push each other by the external pressure, it is possible to form a good-adhered hermetically sealed structure, thereby improving the reliability of the sealing.

Next, the image display device according to the third structure example of the invention in which two glass members are connected together through the corner member will be hereinafter described in detail with reference to FIGS. 8 to 12.

[Embodiment 6]

FIGS. 8 to 11 show a sixth embodiment of the invention. The whole structure of the flat panel display device of the invention is almost the same as that of the conventional flat panel display (image display device) shown in FIGS. 19A and 19B except for the structure of the frame glass 3. Thus, in this embodiment, the structure of the frame glass 3 which is a feature of the invention will be mainly described.

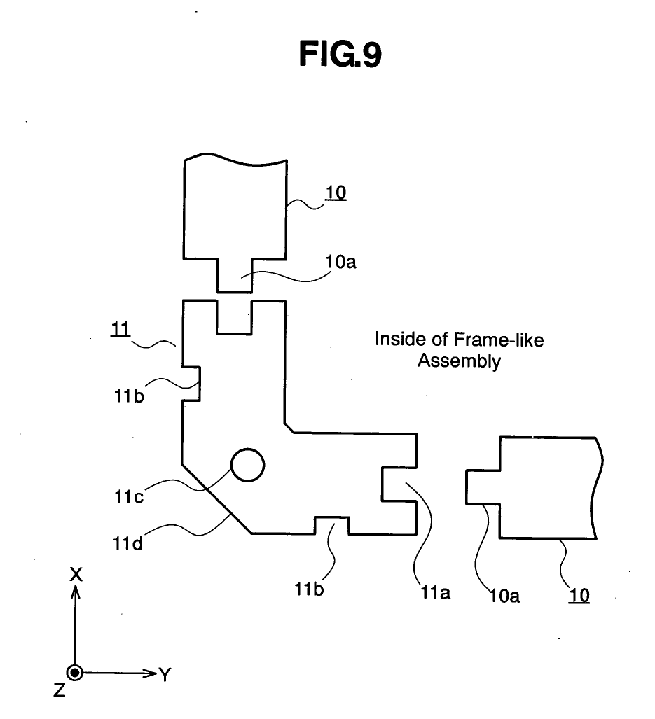

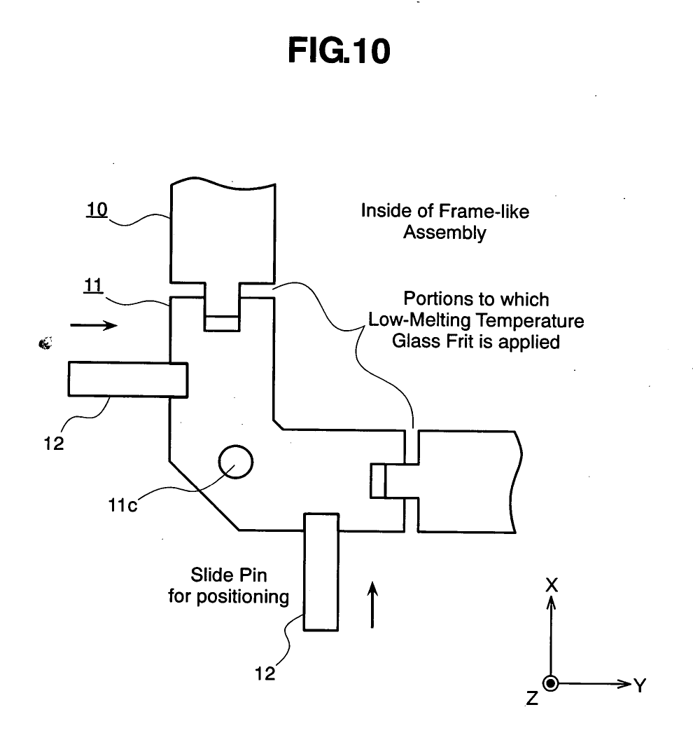

FIG. 8 is a perspective view schematically showing one corner of glass bars 10 and a corner member 11 constituting the frame glass 3. FIG. 9 is a plan view. FIG. 10 is a schematic plan view showing a state of frame assembly.

As shown in FIG. 8, the end of the glass bar 10 is processed beforehand in the simple projection form. On the other hand, the corner member 11 in the form shown in FIG. 8 is molded beforehand out of metal by methods such as casting and cutting. In this embodiment, an alloy containing 48 wt. % iron and 52 wt. % nickel is used as a metal material. Since it is desirable that the thermal expansion coefficient of the metal material be in accordance with that of the glass material used in the cathode plate 1, the anode plate 2, and the glass bars 10, the combination ratio is adjusted as appropriate in the case of changing the glass material to be used. Recessed portions 11a that projected portions 10a fit into are respectively provided at the end surfaces of the corner member 11 in the orthogonal directions.

Although it is possible to form recessed portions at the glass bars 10 and projected portions at the corresponding portions of the corner member 11, forming the recessed portion at the glass bar 10 is more difficult than forming the projected portion. In the case of forming the projected portion, it is possible to form it easily by dicing processing using e.g., a thin disc-like grinder. In the case of forming the recessed portion, it is necessary to use a special processing method such as laser processing in order to prevent breakage of the glass bar during the processing of the recessed portion.

Further, recessed portions 11b that slide pins for positioning 12 touch during assembly are provided around the corner member 11. Reference numeral 11c denotes a hole for conveyance, and reference numeral 11d denotes a chamfered portion.

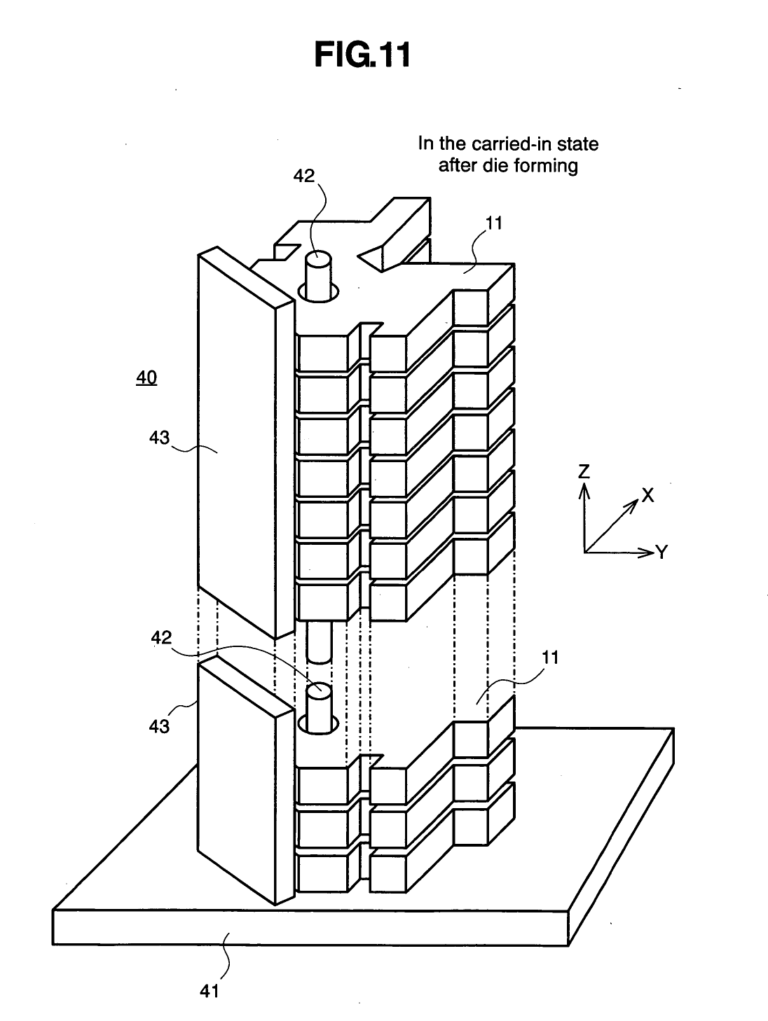

Further, it is practical that the corner member 11 is stored in e.g., a dedicated tray 40 shown in FIG. 11 after molded, in consideration of mass-producibility. FIG. 11 shows the carried-in state of the corner member 11. The tray 40 is composed of a base 41, a pole 42, and an alignment plate 43. Corner members 11 are piled up by passing the pole 42 through the hole for conveyance 11c of the corner member 11 and touching the chamfered portion 11d to the alignment plate 43, thus making possible to store a lot of corner members 11.

In assembling the frame glass 3, first, low melting point glass frit is applied to the bonding surfaces of the four glass bars 10 and the corner members 11 and dried. The glass bars 10 and the corner members 11 are assembled in the form of a frame and pre-baked in a baking furnace. During pre-baking, the slide pins for positioning 12 are touched to the recessed portions of the four corner members 11 for positioning in order to make a specified frame form. Next, dispenser syringe for connection is applied to the surfaces.

On the other hand, dispenser syringe is applied, in the form of the frame glass (a rectangle or a polygon), to the periphery (to which the frame glass is bonded) of the display panel (anode plate) 2 which is prepared by a known method and where a fluorescent screen is formed and the rear panel (cathode plate) 1 where electron sources are formed.

Next, the frame glass 3 pre-baked to which the dispenser syringe for connection is applied is hold between the display panel 2 and the rear panel 1. With depressurization in a baking furnace, the glass frit is melted by heat treatment, thus heating and bonding these parts in one piece.

By thus sealing the display panel 2 and the rear panel 1 through the frame-like glass 3, an image display device (a flat panel display such as an FED) is completed.

In this embodiment, the ends of the glass bars 31 become stuck to the corner members at the time of heating and bonding the panel; therefore, evacuating the display area of the panel to a lower pressure does not cause position deviation of the frame glass, so that the frame glass can be fixed at a desired position for the panel. That is, in the assembly according to the invention, there is a meaning in that the bar-like glass members 10 of the frame glass 3 are temporarily fixed through the corner members 11 so as not to shift inward and can be fixed with glass frit melting at the same temperature range and at the same timing as in sealing the body.

In an electron emission image display device such as an FED, it is possible to make a structure in which a high-voltage lead is not provided at a corner of the panel; therefore, there is little constraint in dimensions and in electric circuits at the corner. If the glass bars do not shift inward, baking in the panel assembling becomes possible by only holding the glass bars lightly from the outside, thereby negating the need for an expensive, high-accuracy baking mold. Further, the glass frame can be assembled and fixed, concurrently with the panel assembling. These features show excellent mass-producibility.

Further, it is effective that the corner member 11 is made of a different material from that of the glass member 10, for example, made of a material having flexibility that absorbs the thermal expansion of the glass member 10. In this embodiment, the corner member 11 is made of an alloy of iron and nickel. Alternatively, it is possible to use any material, as long as it is similar to the glass member 10 in thermal expansion coefficient, such as ceramics mainly containing alumina and zirconia. It is desirable that the material be of high electrical resistance and of high thermal resistance (at least 300° C. to 400° C.). In this case, it becomes possible to make a layout in which a high-voltage lead is provided near a corner in design, and there is an advantage of increasing design flexibility.

In this embodiment, the glass bar 10 in the form of a linear bar has been used. However, it is also possible to use L-shaped glass bars in order to increase the sealing reliability by reducing the number of corner members 11 and reducing the number of joints and shape the frame form by bonding two L-shaped glass bars at two locations. In this case, there is a merit that the cost reduction of the corner member 11 and the improvement of the sealing reliability can be expected.

[Embodiment 7]

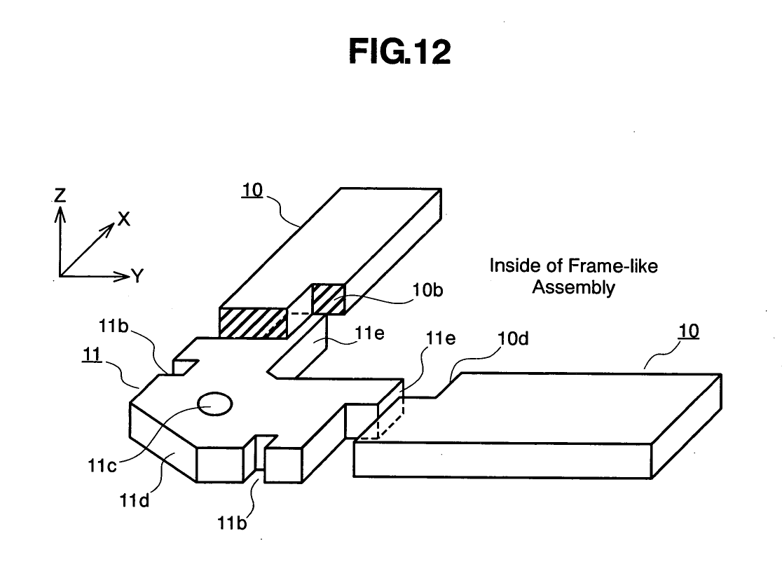

FIGS. 12 to 14 show a seventh embodiment. In this embodiment, as shown in FIG. 12, a cut step 10b is provided at the inside of the end of the glass bar 10, and a projected portion lie for position control is provided at the inside of the end of the corresponding corner member 11, in order to form the frame glass 3.

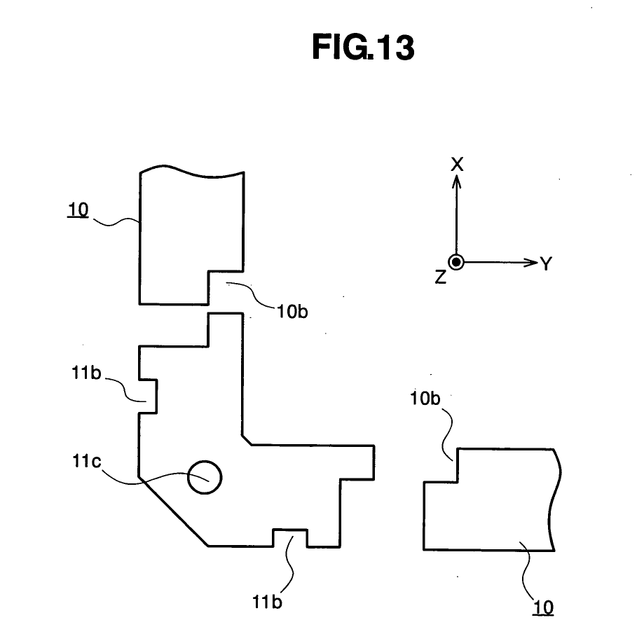

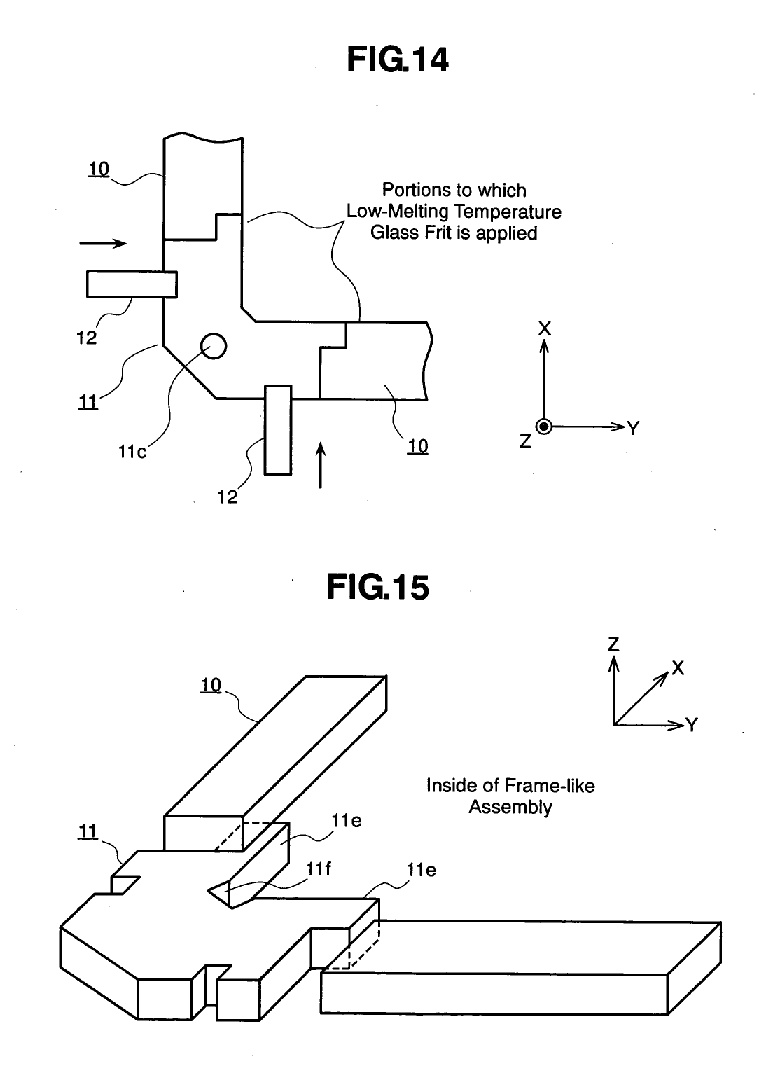

FIG. 12 shows an exploded perspective view of the assembly process of the frame glass 3. FIG. 13 shows a plan view. FIG. 14 shows a plan view showing an assembly in the form of a frame by pre-baking.

In assembling the frame glass 3, as in the case of the sixth embodiment, first, low melting point glass frit is applied to the bonding surfaces of the glass bars 10 and the corner members 11 and dried. The glass bars 10 and the corner members 11 are assembled in the form of a frame and pre-baked in a baking furnace. During pre-baking, as shown in FIG. 14, the slide pins for positioning 12 are touched to the recessed portions of the four corner members 11 for positioning in order to make a specified frame form. Next, dispenser syringe for connection is applied to the surfaces. The processes following this are performed in the same way as in the sixth embodiment. As in the case of the sixth embodiment, without position deviation of the frame glass 3, a high-reliability, hermetically sealed flat panel display can be obtained.

In this embodiment, the number of processes of the end of the glass bar 10 is smaller than that of the sixth embodiment. This increases the possibility that the glass bar deviates outward from the frame. However, the combined use of a method of forming a negative pressure inside during bonding and a method of pushing the side surface of the glass bar inward from the outside with a pushing member (not shown) enables the sealing without position deviation of the glass bar 10. In this case, since the number of processes of the end of the glass bar 10 is small, there is a merit of enabling steady production at low cost.

[Embodiment 8]

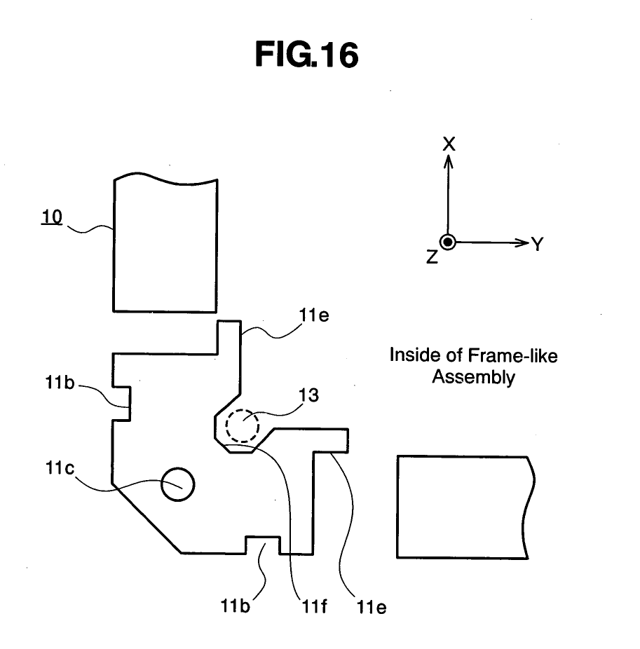

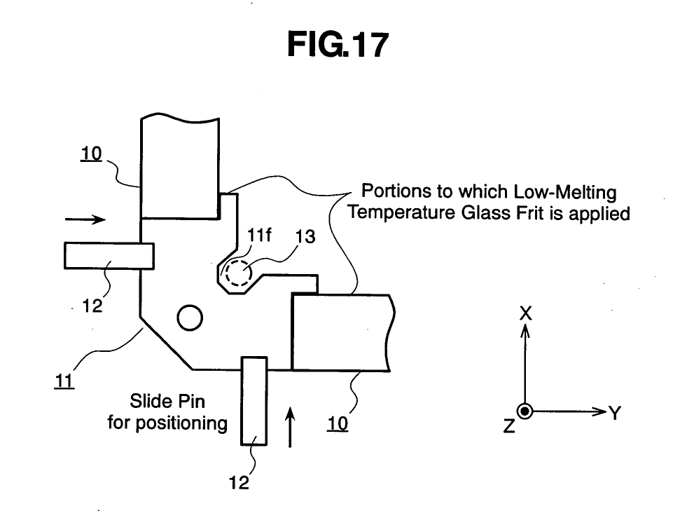

FIGS. 15 to 17 show an eighth embodiment. In this embodiment, the frame glass similar to that of the seventh embodiment is formed. However, a cut step 10b shown in the seventh embodiment is not provided at the inside of the end of the glass bar 10, and a glass bar having flat ends made by merely cutting a glass bar in a specified dimension is used. Further, a connecting end 11e of the corner member 11 is the same as in FIGS. 12 to 14 of the seventh embodiment; however, a recessed portion 11f is provided at a portion corresponding to an exhaust at the panel side and a high-voltage lead passing position 13 so that at least the high-voltage lead can easily pass through it.

In this case as well as in the sixth and seventh embodiments, without position deviation of the frame glass 3, a high-reliability, hermetically sealed flat panel display can be obtained.

In this embodiment, the number of processes of the end of the glass bar 10 is further smaller than those of the sixth and seventh embodiments. In the same way as in the seventh embodiment, the combined use of a method of forming a negative pressure inside during bonding and a method of pushing the side surface of the glass bar inward from the outside with a pushing member (not shown) enables the sealing without position deviation of the glass bar 10. In this case, since the number of processes of the end of the glass bar 10 is smaller, there is a merit of enabling steady production at low cost.

Further, since the connecting end 11e of the corner member 11 is provided at the inside of the glass bar 10 (the frame. 3), the layout in panel design is subject to constraints. However, the recessed portion 11f is provided at the inside of the corner member 11, thereby avoiding the exhaust port at a corner and the high-voltage lead passing position 13. Consequently, there is no actual loss.

As described, this embodiment has exemplified the fixing method using the corner member 11 of the metal fitting molded from low-cost metal, as a frame glass structure. Further, same effect can be obtained in the case of using e.g., alumina or zirconia ceramics instead of metal. The thermal expansion coefficient of the material to be used is desirably close to those of the cathode plate 1, the anode plate 2, and the glass bar 10, and the material preferably has good high-voltage insulation properties and high thermal resistance.

In this case, it becomes possible to make a layout in which a high-voltage lead is provided near the corner member 11, compared to using the corner member 11 made of a conductive alloy, and there is an advantage of increasing design flexibility. Even if a forming error or a distortion during use occurs in the high-voltage lead so that the high-voltage lead touches the corner member 11, the exposure of the high voltage to the outside of the panel can be avoided by using the corner member 11 having good high-voltage insulation properties, which is preferable in product safety design.

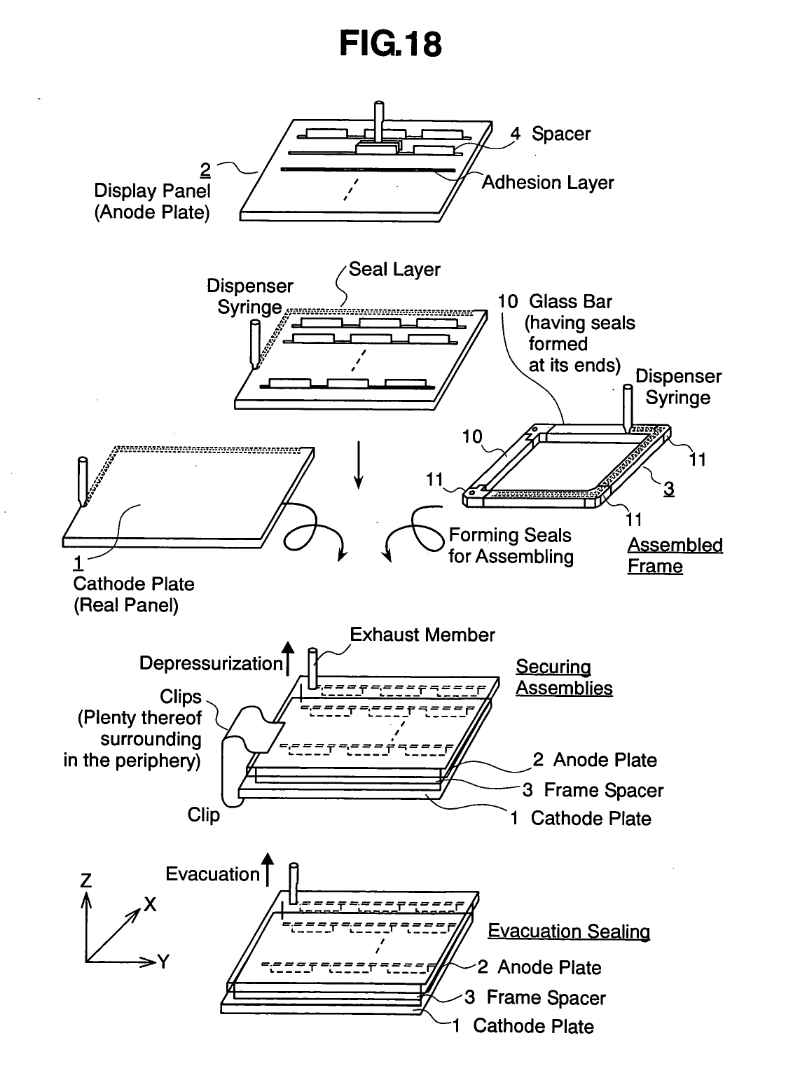

A manufacturing process of the display device using the frame structures of the embodiments will be described below. The simplified flow of the display device described in the sixth to eighth embodiments is shown in FIG. 6 as in the case of the display device according to the second to fifth embodiments. The assembly process of the display device according to the sixth to eighth embodiments is shown by the simplified perspective view of FIG. 18. The form of the assembled frame shown in the simplified perspective view of FIG. 18 is different from that shown in the simplified perspective view of FIG. 7. Further, in the perspective view showing the process of securing the assemblies in FIG. 18, the stacked structure composed of the cathode plate 1, the frame spacer 3, and the anode plate 2 is fixed in the Z direction using a plurality of clips disposed in the X-Y plane, as in the case of FIG. 7. However, the clips are not shown in FIG. 8, except for a representative one. On the anode plate 2 which is a front display panel, spacers 4 are fixed prior to securing the assemblies. The frame spacer 3 is put between the anode plate (display panel) 2 and the cathode plate (rear panel) 1, an exhaust member is installed, and the whole is fixed using jigs or clips and heated. At this time, the volume decreases due to frit melting and the thickness of a frit bonding layer decreases due to the effusion by extrusion from the joints; therefore, it is necessary to use together springs and compression by air pressure difference due to internal depressurization for the mutual fixing of these parts.

Although it is possible to perform the sealing using only spring clips on the periphery, the frame members assembled beforehand or the glass bars and the connecting corner members 11 installed on the spot are prone to position deviation. The application of compression to the whole by internal depressurization can prevent partial rise of the members. In order to prevent the deviation of the frame spacer 3 due to being pushed inside by external pressure at this time, the corner members 11 having the projected portions 11e at the inside of the seventh embodiment are provided in FIG. 18. Even though the frit of the joints of the frame spacer 3 melts again by heating at the time of seal assembling, the frame spacer 3 is not crushed because the corner members 11 support the glass bars 10 against the external pressure. Since the corner members 11 and the glass bars 10 push each other by the external pressure, it is possible to form a good-adhered hermetically sealed structure, thereby improving the reliability of the sealing.

While we have shown and described several embodiments in accordance with the present invention, it is understood that the same is not limited thereto but is susceptible of numerous changes and modifications as known to those skilled in the art, and we therefore do not wish to be limited to the details shown and described herein but intend to cover all such changes and modifications as are encompassed by the scope of the appended claims.

What is claimed is:

1. An image display device, comprising:
a display panel having a fluorescent screen;
a rear panel having an electron source for irradiating the fluorescent screen with an electron beam; and
a frame for hermetically sealing the peripheries of the panels in order to provide a flat space between the two panels,
wherein the frame is composed of a bonded unit in which glass members is extended in at least each one direction from each end of the glass members and shaped are assembled in a frame shape,
at least one of each pair of ends of the glass members connected to each other has a step portion that is cut so that the glass members do not mutually shift to the inside of the flat space, and
the step portion is formed such that a width along at least one direction of the glass member in a plane where the flat space spreads is stretched from the flat space toward the outside of the flat space.

2. An image display device, comprising:
a first substrate having a principal surface on which a plurality of electron sources are formed;
a second substrate being arranged opposite to the principal surface of the first substrate and having a principal surface on which a material layer emitting light by receiving electrons from the electron sources is formed; and
a frame-like assembly interposed between the principal surface of the first substrate and the principal surface of the second substrate to seal an area of the principal surface of the first substrate where the plurality of electron sources are formed together with the principal surface of the second substrate,
wherein the frame-like assembly is shaped by connecting each pair of ends of a plurality of glass members adjacent to each other in a bonding surface of the frame-like assembly to be bonded to one of the principal surface of the first substrate and the principal surface of the second substrate, the plurality of glass members are arranged in a frame shape in the bonding surface,
each of the plurality of the glass members is extended in at least one direction from an end of the glass member in the bonding surface of the frame-like assembly, and has an end face transverse to the at least one extension direction being formed at the end, an inner wall being extended along the at least one extension direction while facing an area enclosed by the frame-like assembly, and an outer wall being extended along the at least one extension direction while opposite to the inner wall to form an outer circumference of the frame-like assembly, each of the end face, the inner wall, and the outer wall is transverse to the bonding surface of the frame-like assembly,
at least one of each pair of the ends of the glass members connected to each other has a first side wall formed between the inner wall and the end face and a second side wall formed between the first side wall and the end face, the first side wall is stretched toward the outer wall along a plane transverse to the inner wall and the at least one extension direction, the second side wall is stretched opposite to the outer wall along another plane transverse to the end face and the first side wall, and each of the first side wall and the second side wall is transverse to the bonding surface of the frame-like assembly to be bonded with another of the each pair of the ends of the glass members connected to each other.

3. An image display device, comprising:
a display panel having a fluorescent screen;
a rear panel having an electron source for irradiating the fluorescent screen with an electron beam; and
a frame for hermetically sealing the peripheries of the panels in order to provide a flat space between the two panels,
wherein the frame is composed of a bonded unit in which a plurality of glass members being extended in at least each one direction from each end of the glass members and formed, an end of one of the glass members and an end of another glass member are connected to each other through a corner metal fitting at a corner of the frame to be assembled in a frame shape.

4. The image display device according to claim 3, wherein the frame is constructed such that an end face transverse to the extension direction of the one glass member at the end of the one glass member and a side face that is along the extension direction of the another glass member and faces an area enclosed by the frame at the end of the another glass member are connected to each other through the corner metal fitting molded in a Z shape.

5. The image display device according to claim 4, wherein one end of the corner metal fitting molded in a Z shape is bent into a 90° angle, and the end of the one glass member is held by the bent one end of the corner metal fitting.

6. The image display device according to claim 3, wherein the frame is composed of a bonded unit in which the end of the one glass member and the end of the another glass member are connected to each other through a corner metal fitting connected and molded in a U shape in accordance with two sides along the extension direction of the one glass member and the extension direction of the another glass member transverse to the extension direction of the one glass member and are assembled in a frame shape.

7. The image display device according to claim 6, wherein the corner metal fitting is molded in an L shape, and respective ends of the corner metal fitting are connected to the two sides transverse to each other.

8. A manufacturing method of an image display device, comprising the steps of:
stacking a display panel having a fluorescent screen, a rear panel having an electron source for irradiating the fluorescent screen with an electron beam, and a frame for hermetically sealing the peripheries of the panels in order to provide a flat space between the two panels; and
fixing a stacked unit in one piece by heat treatment,
wherein, the frame is composed of a bonded unit in which bar-like glass members are assembled in a frame shape, and each of the bar-like glass members has step portions that are cut at both ends so that the glass members do not mutually shift inward.

9. A manufacturing method of an image display device, comprising the steps of:
stacking a display panel having a fluorescent screen, a rear panel having an electron source for irradiating the fluorescent screen with an electron beam, and a frame for hermetically sealing the peripheries of the panels in order to provide a flat space between the two panels; and
fixing a stacked unit in one piece by heat treatment,
wherein, the frame is composed of a bonded unit in which an end of one of the bar-like glass members and an end of another bar-like glass member are connected to each other through a corner metal fitting to be assembled in a frame shape.

10. The manufacturing method of the image display device according to claim 8, wherein in the step of fixing a stacked unit in one piece by heat treatment, the inside of the flat space between the two panels is evacuated and depressurized compared to the outside of the flat space in order to ensure the mutual bonding of the two panels and the frame.

11. An image display device, comprising:
a display panel having a fluorescent screen;
a rear panel having an electron source for irradiating the fluorescent screen with an electron beam; and
a frame for hermetically sealing the peripheries of the panels in order to provide a flat space between the two panels,
wherein the frame is composed of a bonded unit assembled in a frame shape by mutually connecting, at each corner of the frame, an end of a bar-like glass member being extended in a first direction to a corner and an end of another bar-like glass member being extended in a second direction transverse to the first direction to the corner through a corner member having respective ends in the first direction and the second direction, and
each end of the corner member is provided with a surface supporting the bar-like glass member or the another bar-like glass member.

12. The image display device according to claim 11, wherein a projected portion is formed on each surface of the ends of the bar-like glass member and the another bar-like glass member and a recessed portion corresponding to the projected portion of the end formed on each of the bar-like glass members is formed on each surface of the ends of the corner member, and
the bar-like glass member, the another bar-like glass member, and the corner member are mutually supported by fitting the projected portion formed on each of the bar-like glass member and the another bar-like glass member into the recessed portion formed on each surface of the corner member.

13. The image display device according to claim 11, wherein a cut step portion is formed on a side of the end of the bar-like glass member facing an area enclosed by the frame, a projected portion opposite to the step portion formed on the end of the bar-like glass member is formed on a side of the end of the corner member facing the area, and
the step portion and the projected portion is combined into one piece, thereby constructing the frame.

14. The image display device according to claim 11, wherein the end of the bar-like glass member takes in the projected portion formed on the side of the end of the corner member facing the area enclosed by the frame as an inner wall, thereby constructing the frame.

15. The image display device according to claim 11, wherein recessed portions for positioning are provided in two directions on a side face of the corner member that is an outer circumference of the frame.

16. The image display device according to claim 11, wherein a hole for conveyance is provided at roughly a center portion of the corner member.

17. The image display device according to claim 11, wherein a recessed portion is provided on a side of the end of the corner member facing an area enclosed by the frame.

18. A manufacturing method of an image display device, comprising the steps of:
stacking a display panel having a fluorescent screen, a rear panel having an electron source for irradiating the fluorescent screen with an electron beam, and a frame for hermetically sealing the peripheries of the panels in order to provide a flat space between the two panels; and
fixing a stacked unit in one piece by heat treatment under pressure,
wherein, the frame is composed of a bonded unit in which four bar-like glass members are assembled in a frame shape through a corner member, and
a projected portion provided at the inside of an end of the corner member restrains the inside of an end of the bar-like glass member from causing a position shift.

19. The manufacturing method of the image display device according to claim 18, wherein in the step of fixing a stacked unit in one piece by heat treatment, the inside of the flat space between the two panels is evacuated and depressurized compared to the outside of the flat space in order to ensure the mutual bonding of the two panels and the frame.
